(19) United States
(12) Patent Application Publication
(10) Pub. No.: US 2021/0051508 A1
(43) Pub. Date: Feb. 18, 2021

(54) METHOD OF REPORTING CHANNEL STATE INFORMATION IN WIRELESS COMMUNICATION SYSTEM AND DEVICE THEREFOR

(71) Applicant: LG ELECTRONICS INC., Seoul (KR)

(72) Inventors: Jaehoon CHUNG, Seoul (KR); Haewook PARK, Seoul (KR); Jiwon KANG, Seoul (KR)

(21) Appl. No.: 16/993,964

(22) Filed: Aug. 14, 2020

Related U.S. Application Data
(60) Provisional application No. 62/887,628, filed on Aug. 15, 2019.

(30) Foreign Application Priority Data
Oct. 4, 2019 (KR) 10-2019-0123192

(51) Int. Cl. H04W 24/10; H04L 5/00; H04W 24/08; H04B 7/06

(52) U.S. Cl. CPC H04W 24/10; H04B 7/0626; H04W 24/08; H04L 5/0048

(57) ABSTRACT

Disclosed are a method of reporting channel state information (CSI) in a wireless communication system and a device therefor. Specifically, a method of reporting channel state information (CSI) by a user equipment (UE) in a wireless communication system includes receiving a reference signal from a base station (BS), calculating CSI based on the reference signal, wherein the CSI includes information related to coefficients, elements of the information related to the coefficients are classified into a plurality of groups based on priority values, respectively, and the priority values increase in order in which a higher index and a lower index of indices of a frequency domain associated with the elements sequentially alternate each other based on a predefined specific index, and transmitting, to the BS, a CSI reporting configured by omitting a specific group according to priorities of the plurality of groups.

### CROSS-REFERENCE TO RELATED APPLICATIONS

This application claims the benefit of U.S. Provisional Application No. 62/887,628 filed on Aug. 15, 2019, and KR Application No. 10-2019-0123192 filed on Oct. 4, 2019. The contents of this application are hereby incorporated by reference in its entirety.

### BACKGROUND OF THE INVENTION

### Field of the Invention

The present disclosure relates to a wireless communication system, and more particularly, to a method of reporting channel state information in consideration of a payload of the channel state information and a device supporting the same.

### Related Art

A mobile communication system has been developed to provide a voice service while ensuring an activity of a user. However, in the mobile communication system, not only a voice but also a data service is extended. At present, due to an explosive increase in traffic, there is a shortage of resources and users demand a higher speed service, and as a result, a more developed mobile communication system is required.

Requirements of a next-generation mobile communication system should be able to support acceptance of explosive data traffic, a dramatic increase in per-user data rate, acceptance of a significant increase in the number of connected devices, very low end-to-end latency, and high-energy efficiency. To this end, various technologies are researched, which include dual connectivity, massive multiple input multiple output (MIMO), in-band full duplex, non-orthogonal multiple access (NOMA), super wideband support, device networking, and the like.

### SUMMARY OF THE INVENTION

The present disclosure proposes a method of reporting channel state information (CSI) in a wireless communication system.

Specifically, the present disclosure proposes a method of omitting a part of CSI if a size of a payload of the CSI is larger than a capacity of resource allocated for the CSI in consideration of the payload of the CSI.

In addition, the present disclosure proposes a method of determining priority of CSI parameters to perform omission on a part of CSI.

In addition, the present disclosure proposes a method of reporting a CSI by configuring the CSI to include a first part and a second part.

Technical objects to be achieved by the present disclosure are not limited to the aforementioned technical objects, and other technical objects not described above may be evidently understood by a person having ordinary skill in the art to which the present disclosure pertains from the following description.

The present disclosure provides a method for transmitting/receiving channel state information in a wireless communication system.

More specifically, the method of reporting channel state information (CSI) by a user equipment (UE) in a wireless communication system according to an embodiment of the present disclosure includes: receiving a reference signal from a base station (BS); calculating CSI based on the reference signal, wherein the CSI includes information related to coefficients, elements of the information related to the coefficients are classified into a plurality of groups based on priority values, respectively, and the priority values increase in order in which a higher index and a lower index of indices of a frequency domain associated with the elements sequentially alternate each other based on a predefined specific index; and transmitting, to the BS, a CSI reporting configured by omitting a specific group according to priorities of the plurality of groups.

Furthermore, the predefined specific index may be associated with an index of the frequency domain of a strongest coefficient among the coefficients

Furthermore, the predefined specific index may be 0.

Furthermore, the priority values may be determined based on i) layer indices, ii) indices of a spatial domain associated with the respective elements, and iii) indices of the frequency domain associated with the respective elements.

Furthermore, the priority values may increase in ascending order of the indices of the spatial domain.

Furthermore, a priority of the respective elements may be higher as the priority values are smaller.

Furthermore, a priority of i) an index of the spatial domain of the strongest coefficient and ii) an index of the spatial domain corresponding to a beam having opposite polarization with respect to a beam corresponding to the strongest coefficient may be highest.

Furthermore, the CSI reporting may be transmitted via a physical uplink shared channel (PUSCH).

Furthermore, the CSI reporting may include a first part and a second part, and the specific group to be included in the second portion is omitted.

Furthermore, the CSI reporting may further include information related to omission of the specific group.

Furthermore, the information related to the omission may include information on at least one of i) whether to omit, ii) an omission subject, or iii) an omission quantity.

Furthermore, the information related to the coefficients may include at least one of i) information on a amplitude coefficient, ii) information on a phase coefficient, or iii) bitmap information related to the amplitude coefficient and the phase coefficient.

Furthermore, the method may further include receiving configuration information related to the CSI from the BS, wherein a resource region for the CSI reporting may be allocated based on the configuration information, and a payload size of the calculated CSI exceeds the resource region.

A user equipment (UE) transmitting and receiving data in a wireless communication system according to an embodiment of the present disclosure includes: at least one transceiver; at least one processor; and at least one memory configured to store instructions regarding operations executed by the at least one processor and connected to the at least one processor, wherein the operations include: receiving, from a base station (BS) through the at least one transceiver, a reference signal; calculating channel state information (CSI) based on the reference signal, wherein the CSI includes information related to coefficients, elements of the information related to the coefficients are classified into a plurality of groups based on priority values, respectively, and the priority values increase in order in which a higher index and a lower index of indices of a frequency domain associated with the elements sequentially alternate each other based on a predefined specific index; and transmitting, to the BS through the at least one transceiver, a CSI reporting configured by omitting a specific group according to priorities of the plurality of groups.

Furthermore, the predefined specific index may be associated with an index of the frequency domain of a strongest coefficient among the coefficients.

Furthermore, the priority values may be determined based on i) layer indices, ii) indices of a spatial domain associated with the respective elements, and iii) indices of the frequency domain associated with the respective elements.

Furthermore, the priority values may increase in ascending order of the indices of the spatial domain.

A method of receiving channel state information (CSI) by a base station (BS) in a wireless communication system according to an embodiment of the present disclosure includes: transmitting CSI-related configuration information to a user equipment (UE); transmitting a reference signal to the UE; and receiving CSI measured based on the reference signal from the UE, wherein the CSI includes information related to coefficients, elements of the information related to the coefficients are classified into a plurality of groups based on priority values, respectively, the priority values increase in order in which a higher index and a lower index of indices of a frequency domain associated with the elements sequentially alternate each other based on a predefined specific index, and a specific group is omitted according to priorities of the plurality of groups.

A base station (BS) for transmitting and receiving data in a wireless communication system according to an embodiment of the present disclosure includes: at least one transceiver; at least one processor; and at least one memory configured to store instructions regarding operations executed by the at least one processor and connected to the at least one processor, wherein the operations include: transmitting channel state information (CSI)-related configuration information to a user equipment (UE); transmitting a reference signal to the UE; and receiving CSI measured based on the reference signal from the UE, wherein the CSI includes information related to coefficients, elements of the information related to the coefficients are classified into a plurality of groups based on priority values, respectively, the priority values increase in order in which a higher index and a lower index of indices of a frequency domain associated with the elements sequentially alternate each other based on a predefined specific index, and a specific group is omitted according to priorities of the plurality of groups.

In a device including at least one memory and at least one processor functionally connected to the at least one memory according to an embodiment of the present disclosure, the at least one processor controls the device to receive a reference signal, to calculate channel state information (CSI) based on the reference signal, wherein the CSI includes information related to coefficients, elements of the information related to the coefficients are classified into a plurality of groups based on priority values, respectively, and the priority values increase in order in which a higher index and a lower index of indices of a frequency domain associated with the elements sequentially alternate each other based on a predefined specific index, and to transmit a CSI reporting configured by omitting a specific group according to priorities of the plurality of groups.

In a non-transitory computer-readable medium storing at least one instruction according to an embodiment of the present disclosure, the at least one instruction executable by at least one processor includes an instruction for a user equipment (UE) to receive a reference signal, to calculate channel state information (CSI) based on the reference signal, wherein the CSI includes information related to coefficients, elements of the information related to the coefficients are classified into a plurality of groups based on priority values, respectively, and the priority values increase in order in which a higher index and a lower index of indices of a frequency domain associated with the elements sequentially alternate each other based on a predefined specific index, and to transmit a CSI reporting configured by omitting a specific group according to priorities of the plurality of groups.

### BRIEF DESCRIPTION OF THE DRAWINGS

The accompany drawings, which are included to provide a further understanding of the present disclosure and are incorporated on and constitute a part of this disclosure illustrate embodiments of the present disclosure and together with the description serve to explain the principles of the present disclosure.

FIG. 1 is a diagram illustrating an example of an overall system structure of NR to which a method proposed in the present disclosure may be applied.

FIG. 2 illustrates a relationship between an uplink frame and a downlink frame in a wireless communication system to which a method proposed in the present disclosure may be applied.

FIG. 3 illustrates an example of a frame structure in an NR system.

FIG. 4 illustrates an example of a resource grid supported by a wireless communication system to which a method proposed in the present disclosure may be applied.

FIG. 5 illustrates examples of a resource grid for each antenna port and numerology to which a method proposed in the present disclosure may be applied.

FIG. 6 illustrates physical channels and general signal transmission used in a 3GPP system.

FIG. 7 is a flowchart showing an example of a CSI-related procedure.

FIG. 8A and FIG. 8B show examples of index remapping in a precoding matrix based on the strongest coefficient indicator (SCI).

FIG. 9 shows an example of setting three levels of omission priority in a frequency domain together with pair SD bases.

FIG. 10A and FIG. 10B show examples of a delay profile of a wireless channel.

FIG. 11 shows an example of setting omission priority in a spatial domain SD together with a single frequency domain FD basis.

FIG. 12 shows an example of a signaling flowchart between a user equipment (UE) and a base station (BS) to which the method and/or embodiment proposed in this disclosure may be applied.

FIG. 13 is an example of an operation flowchart of a UE performing CSI reporting to which the method and/or embodiment proposed in the present disclosure may be applied.

FIG. 14 is an example of an operation flowchart of a BS to which the method and/or embodiment proposed in the present disclosure may be applied.

FIG. 15 illustrates a communication system (1) applied to the present disclosure.

FIG. 16 illustrates a wireless device which may be applied to the present disclosure.

FIG. 17 illustrates a signal processing circuit for a transmit signal.

FIG. 18 illustrates another example of a wireless device applied to the present disclosure.

FIG. 19 illustrates a portable device applied to the present disclosure.

### DETAILED DESCRIPTION OF THE EMBODIMENTS

Reference will now be made in detail to embodiments of the disclosure, examples of which are illustrated in the accompanying drawings. A detailed description to be disclosed below together with the accompanying drawing is to describe exemplary embodiments of the present invention and not to describe a unique embodiment for carrying out the present invention. The detailed description below includes details to provide a complete understanding of the present invention. However, those skilled in the art know that the present invention may be carried out without the details.

In some cases, in order to prevent a concept of the present invention from being ambiguous, known structures and devices may be omitted or illustrated in a block diagram format based on core functions of each structure and device.

Hereinafter, downlink (DL) means communication from the base station to the terminal and uplink (UL) means communication from the terminal to the base station. In downlink, a transmitter may be part of the base station, and a receiver may be part of the terminal. In downlink, the transmitter may be part of the terminal and the receiver may be part of the terminal. The base station may be expressed as a first communication device and the terminal may be expressed as a second communication device. A base station (BS) may be replaced with terms including a fixed station, a Node B, an evolved-NodeB (eNB), a Next Generation NodeB (gNB), a base transceiver system (BTS), an access point (AP), a network (5G network), an AI system, a road side unit (RSU), a vehicle, a robot, an Unmanned Aerial Vehicle (UAV), an Augmented Reality (AR) device, a Virtual Reality (VR) device, and the like. Further, the terminal may be fixed or mobile and may be replaced with terms including a User Equipment (UE), a Mobile Station (MS), a user terminal (UT), a Mobile Subscriber Station (MSS), a Subscriber Station (SS), an Advanced Mobile Station (AMS), a Wireless Terminal (WT), a Machine-Type Communication (MTC) device, a Machine-to-Machine (M2M) device, and a Device-to-Device (D2D) device, the vehicle, the robot, an A module, the Unmanned Aerial Vehicle (UAV), the Augmented Reality (AR) device, the Virtual Reality (VR) device, and the like.

The following technology may be used in various radio access system including CDMA, FDMA, TDMA, OFDMA, SC-FDMA, and the like. The CDMA may be implemented as radio technology such as Universal Terrestrial Radio Access (UTRA) or CDMA2000. The TDMA may be implemented as radio technology such as a global system for mobile communications (GSM)/general packet radio service (GPRS)/enhanced data rates for GSM evolution (EDGE). The OFDMA may be implemented as radio technology such as Institute of Electrical and Electronics Engineers (IEEE) 802.11 (Wi-Fi), IEEE 802.16 (WiMAX), IEEE 802.20, Evolved UTRA (E-UTRA), or the like. The UTRA is a part of Universal Mobile Telecommunications System (UMTS). 3rd Generation Partnership Project (3GPP) Long Term Evolution (LTE) is a part of Evolved UMTS (E-UMTS) using the E-UTRA and LTE-Advanced (A)/LTE-A pro is an evolved version of the 3GPP LTE. 3GPP NR (New Radio or New Radio Access Technology) is an evolved version of the 3GPP LTE/LTE-A/LTE-A pro.

For clarity of description, the technical spirit of the present invention is described based on the 3GPP communication system (e.g., LTE-A or NR), but the technical spirit of the present invention are not limited thereto. LTE means technology after 3GPP TS 36.xxx Release 8. In detail, LTE technology after 3GPP TS 36.xxx Release 10 is referred to as the LTE-A and LTE technology after 3GPP TS 36.xxx Release 13 is referred to as the LTE-A pro. The 3GPP NR means technology after TS 38.xxx Release 15. The LTE/NR may be referred to as a 3GPP system. “xxx” means a standard document detail number. The LTE/NR may be collectively referred to as the 3GPP system. Matters disclosed in a standard document opened before the present invention may be referred to for a background art, terms, omissions, etc., used for describing the present invention. For example, the following documents may be referred to.

3GPP LTE
36.211: Physical channels and modulation
36.212: Multiplexing and channel coding
36.213: Physical layer procedures
36.300: Overall description
36.331: Radio Resource Control (RRC)

3GPP NR
38.211: Physical channels and modulation
38.212: Multiplexing and channel coding
38.213: Physical layer procedures for control
38.214: Physical layer procedures for data
38.300: NR and NG-RAN Overall Description
38.331: Radio Resource Control (RRC) protocol specification

As more and more communication devices require larger communication capacity, there is a need for improved mobile broadband communication compared to the existing radio access technology (RAT). Further, massive machine type communications (MTCs), which provide various services anytime and anywhere by connecting many devices and objects, are one of the major issues to be considered in the next generation communication. In addition, a communication system design considering a service/UE sensitive to reliability and latency is being discussed. The introduction of next generation radio access technology considering enhanced mobile broadband communication (eMBB), massive MTC (mMTC), ultra-reliable and low latency communication (URLLC) is discussed, and in the present invention, the technology is called new RAT for convenience. The NR is an expression representing an example of 5G radio access technology (RAT).

Three major requirement areas of 5G include (1) an enhanced mobile broadband (eMBB) area, (2) a massive machine type communication (mMTC) area and (3) an ultra-reliable and low latency communications (URLLC) area.

Some use cases may require multiple areas for optimization, and other use case may be focused on only one key performance indicator (KPI). 5G support such various use cases in a flexible and reliable manner.

eMBB is far above basic mobile Internet access and covers media and entertainment applications in abundant bidirectional tasks, cloud or augmented reality. Data is one of key motive powers of 5G, and dedicated voice services may not be first seen in the 5G era. In 5G, it is expected that voice will be processed as an application program using a data connection simply provided by a communication system. Major causes for an increased traffic volume include an increase in the content size and an increase in the number of applications that require a high data transfer rate. Streaming service (audio and video), dialogue type video and mobile Internet connections will be used more widely as more devices are connected to the Internet. Such many application programs require connectivity always turned on in order to push real-time information and notification to a user. A cloud storage and application suddenly increases in the mobile communication platform, and this may be applied to both business and entertainment. Furthermore, cloud storage is a special use case that tows the growth of an uplink data transfer rate. 5G is also used for remote business of cloud. When a tactile interface is used, further lower end-to-end latency is required to maintain excellent user experiences. Entertainment, for example, cloud game and video streaming are other key elements which increase a need for the mobile broadband ability. Entertainment is essential in the smartphone and tablet anywhere including high mobility environments, such as a train, a vehicle and an airplane. Another use case is augmented reality and information search for entertainment. In this case, augmented reality requires very low latency and an instant amount of data.

Furthermore, one of the most expected 5G use case relates to a function capable of smoothly connecting embedded sensors in all fields, that is, mMTC. Until 2020, it is expected that potential IoT devices will reach 20.4 billions. The industry IoT is one of areas in which 5G performs major roles enabling smart city, asset tracking, smart utility, agriculture and security infra.

URLLC includes a new service which will change the industry through remote control of major infra and a link having ultra reliability/low available latency, such as a self-driving vehicle. A level of reliability and latency is essential for smart grid control, industry automation, robot engineering, drone control and adjustment.

Multiple use cases are described more specifically.

5G may supplement fiber-to-the-home (FTTH) and cable-based broadband (or DOCSIS) as means for providing a stream evaluated from gigabits per second to several hundreds of mega bits per second. Such fast speed is necessary to deliver TV with resolution of 4K or more (6K, 8K or more) in addition to virtual reality and augmented reality. Virtual reality (VR) and augmented reality (AR) applications include immersive sports games. A specific application program may require a special network configuration. For example, in the case of VR game, in order for game companies to minimize latency, a core server may need to be integrated with the edge network server of a network operator.

An automotive is expected to be an important and new motive power in 5G, along with many use cases for the mobile communication of an automotive. For example, entertainment for a passenger requires a high capacity and a high mobility mobile broadband at the same time. The reason for this is that future users continue to expect a high-quality connection regardless of their location and speed. Another use example of the automotive field is an augmented reality dashboard. The augmented reality dashboard overlaps and displays information, identifying an object in the dark and notifying a driver of the distance and movement of the object, over a thing seen by the driver through a front window. In the future, a wireless module enables communication between automotives, information exchange between an automotive and a supported infrastructure, and information exchange between an automotive and other connected devices (e.g., devices accompanied by a pedestrian). A safety system guides alternative courses of a behavior so that a driver may drive more safely, thereby reducing a danger of an accident. A next step will be a remotely controlled or self-driven vehicle. This requires very reliable, very fast communication between different self-driven vehicles and between an automotive and infra. In the future, a self-driven vehicle may perform all driving activities, and a driver will be focused on things other than traffic, which cannot be identified by an automotive itself. Technical requirements of a self-driven vehicle require ultra-low latency and ultra-high speed reliability so that traffic safety is increased up to a level which cannot be achieved by a person.

A smart city and smart home mentioned as a smart society will be embedded as a high-density radio sensor network. The distributed network of intelligent sensors will identify the cost of a city or home and a condition for energy-efficient maintenance. A similar configuration may be performed for each home. All of a temperature sensor, a window and heating controller, a burglar alarm and home appliances are wirelessly connected. Many of such sensors are typically a low data transfer rate, low energy and a low cost. However, for example, real-time HD video may be required for a specific type of device for surveillance.

The consumption and distribution of energy including heat or gas are highly distributed and thus require automated control of a distributed sensor network. A smartgrid collects information, and interconnects such sensors using digital information and a communication technology so that the sensors operate based on the information. The information may include the behaviors of a supplier and consumer, and thus the smart grid may improve the distribution of fuel, such as electricity, in an efficient, reliable, economical, production-sustainable and automated manner. The smart grid may be considered to be another sensor network having small latency.

A health part owns many application programs which reap the benefits of mobile communication. A communication system may support remote treatment providing clinical treatment at a distant place. This helps to reduce a barrier for the distance and may improve access to medical services which are not continuously used at remote farming areas. Furthermore, this is used to save life in important treatment and an emergency condition. A radio sensor network based on mobile communication may provide remote monitoring and sensors for parameters, such as the heart rate and blood pressure.

Radio and mobile communication becomes increasingly important in the industry application field. Wiring requires a high installation and maintenance cost. Accordingly, the possibility that a cable will be replaced with reconfigurable radio links is an attractive opportunity in many industrial fields. However, to achieve the possibility requires that a radio connection operates with latency, reliability and capacity similar to those of the cable and that management is simplified. Low latency and a low error probability is a new requirement for a connection to 5G.

Logistics and freight tracking is an important use case for mobile communication, which enables the tracking inventory and packages anywhere using a location-based information system. The logistics and freight tracking use case typically requires a low data speed, but a wide area and reliable location information.

In a new RAT system including NR uses an OFDM transmission scheme or a similar transmission scheme thereto. The new RAT system may follow OFDM parameters different from OFDM parameters of LTE. Alternatively, the new RAT system may follow numerology of conventional LTE/LTE-A as it is or have a larger system bandwidth (e.g., 100 MHz). Alternatively, one cell may support a plurality of numerologies. In other words, UEs that operate with different numerologies may coexist in one cell.

The numerology corresponds to one subcarrier spacing in a frequency domain. Different numerologies may be defined by scaling reference subcarrier spacing to an integer N.

### Definition of Terms

eLTE eNB: The eLTE eNB is the evolution of eNB that supports connectivity to EPC and NGC.

gNB: A node which supports the NR as well as connectivity to NGC.

New RAN: A radio access network which supports either NR or E-UTRA or interfaces with the NGC.

Network slice: A network slice is a network created by the operator customized to provide an optimized solution for a specific market scenario which demands specific requirements with end-to-end scope.

Network function: A network function is a logical node within a network infrastructure that has well-defined external interfaces and well-defined functional behavior.

NG-C: A control plane interface used on NG2 reference points between new RAN and NGC.

NG-U: A user plane interface used on NG3 references points between new RAN and NGC.

Non-standalone NR: A deployment configuration where the gNB requires an LTE eNB as an anchor for control plane connectivity to EPC, or requires an eLTE eNB as an anchor for control plane connectivity to NGC.

Non-standalone E-UTRA: A deployment configuration where the eLTE eNB requires a gNB as an anchor for control plane connectivity to NGC.

User plane gateway: A termination point of NG-U interface.

Overview of System

FIG. 1 illustrates an example of an overall structure of a NR system to which a method proposed in the present invention is applicable.

Referring to FIG. 1, an NG-RAN consists of gNBs that provide an NG-RA user plane (new AS sublayer/PDCP/RLC/MAC/PHY) and control plane (RRC) protocol terminations for a user equipment (UE).

The gNBs are interconnected with each other by means of an Xn interface.

The gNBs are also connected to an NGC by means of an NG interface.

More specifically, the gNBs are connected to an access and mobility management function (AMF) by means of an N2 interface and to a user plane function (UPF) by means of an N3 interface.

NR (New Rat) Numerology and frame structure

In the NR system, multiple numerologies may be supported. The numerologies may be defined by subcarrier spacing and a CP (Cyclic Prefix) overhead. Spacing between the plurality of subcarriers may be derived by scaling basic subcarrier spacing into an integer N (or A). In addition, although a very low subcarrier spacing is assumed not to be used at a very high subcarrier frequency, a numerology to be used may be selected independent of a frequency band.

In addition, in the NR system, a variety of frame structures according to the multiple numerologies may be supported.

Hereinafter, an orthogonal frequency division multiplexing (OFDM) numerology and a frame structure, which may be considered in the NR system, will be described.

A plurality of OFDM numerologies supported in the NR system may be defined as in Table 1.

TABLE 1

| | Δf = 2^{μ} · 15 | |
|---|---|---|
| μ | [kHz] | Cyclic prefix |
| 0 | 15 | Normal |
| 1 | 30 | Normal |
| 2 | 60 | Normal, Extended |
| 3 | 120 | Normal |
| 4 | 240 | Normal |

The NR supports multiple numerologies (or subcarrier spacing (SCS)) for supporting various 5G services. For example, when the SCS is 15 kHz, a wide area in traditional cellular bands is supported and when the SCS is 30 kHz/60 kHz, dense-urban, lower latency, and wider carrier bandwidth are supported, and when the SCS is 60 kHz or higher therethan, a bandwidth larger than 24.25 GHz is supported in order to overcome phase noise.

An NR frequency band is defined as frequency ranges of two types (FR1 and FR2). FR1 and FR2 may be configured as shown in Table 2 below. Further, FR2 may mean a millimeter wave (mmW).

TABLE 2

| Frequency | Corresponding | |
|---|---|---|
| Range | frequency | Subcarner |
| designation | range | Spacing |
| FR1 | 410 MHz-7125 MHz | 15, 30, 60 kHz |
| FR2 | 24250 MHz-52600 MHz | 60, 120, 240 kHz |

Regarding a frame structure in the NR system, a size of various fields in the time domain is expressed as a multiple of a time unit of Tₛ=1/(Δfₘₐₓ·N_{f}). In this case, Δfₘₐₓ=480·10³, and N_{f}=4096. DL and UL transmission is configured as a radio frame having a section of T_{f}=(ΔfₘₐₓN_{f}/100)·Tₛ=10 ms. The radio frame is composed of ten subframes each having a section of T_{sf}=(ΔfₘₐₓN_{f}/1000)·Tₛ=1 ms. In this case, there may be a set of UL frames and a set of DL frames.

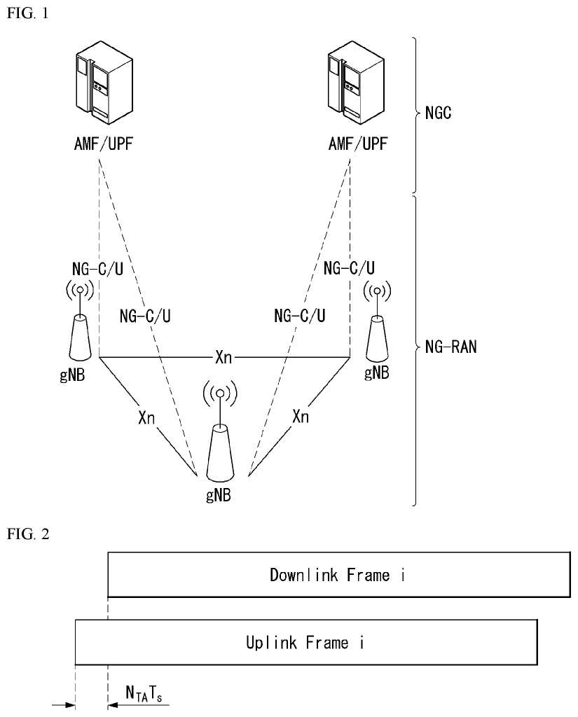

FIG. 2 illustrates a relation between an uplink frame and a downlink frame in a wireless communication system to which a method proposed in the present invention is applicable.

As illustrated in FIG. 2, uplink frame number i for transmission from a user equipment (UE) shall start T_{TA}=N_{TA}Tₛ before the start of a corresponding downlink frame at the corresponding UE.

Regarding the numerology μ, slots are numbered in increasing order of nₛ^{μ}∈{0, . . . , N_{subframe}^{slots,μ}−1} within a subframe and are numbered in increasing order of n_{s, f}^{μ}∈{0, . . . , N_{frame}^{slots,μ}−1} within a radio frame. One slot consists of consecutive OFDM symbols of N_{symb}^{μ}, and N_{symb}^{μ} is determined depending on a numerology used and slot configuration. The start of slots nₛ^{μ} in a subframe is aligned in time with the start of OFDM symbols nₛ^{μ}N_{symb}^{μ} in the same subframe.

Not all UEs are able to transmit and receive at the same time, and this means that not all OFDM symbols in a downlink slot or an uplink slot are available to be used.

Table 3 represents the number N_{symb}^{slot} of OFDM symbols per slot, the number Nₛₗₒₜ^{frame,μ} of slots per radio frame, and the number Nₛₗₒₜ^{subframe,μ} of slots per subframe in a normal CP. Table 4 represents the number of OFDM symbols per slot, the number of slots per radio frame, and the number of slots per subframe in an extended CP.

TABLE 3

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame,μ} | Nₛₗₒₜ^{subframe,μ} |
|---|---|---|---|
| 2 | 12 | 40 | 4 |

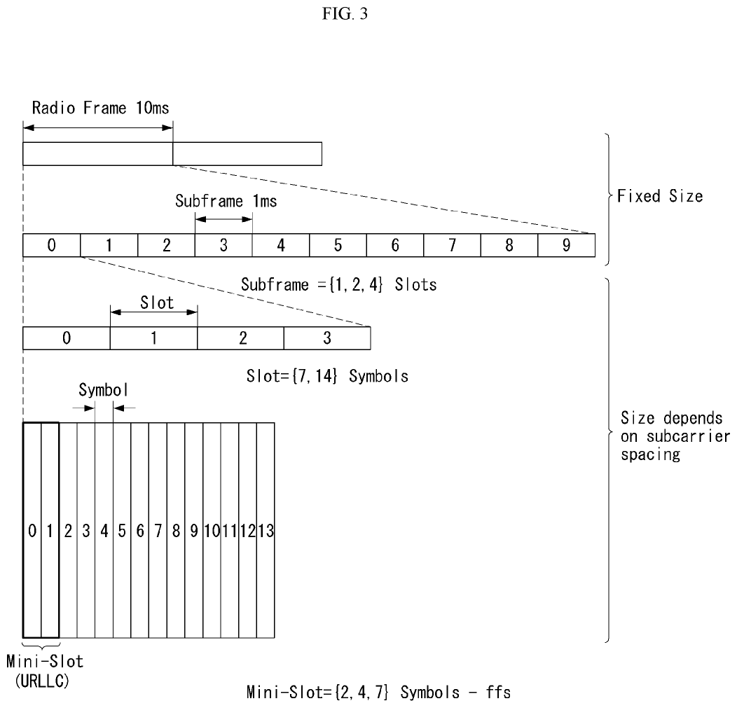

FIG. 3 illustrates an example of a frame structure in a NR system. FIG. 3 is merely for convenience of explanation and does not limit the scope of the present invention.

In Table 4, in case of μ=2, i.e., as an example in which a subcarrier spacing (SCS) is 60 kHz, one subframe (or frame) may include four slots with reference to Table 3, and one subframe={1, 2, 4} slots shown in FIG. 3, for example, the number of slot(s) that may be included in one subframe may be defined as in Table 3.

Further, a mini-slot may consist of 2, 4, or 7 symbols, or may consist of more symbols or less symbols.

In regard to physical resources in the NR system, an antenna port, a resource grid, a resource element, a resource block, a carrier part, etc. May be considered.

Hereinafter, the above physical resources that may be considered in the NR system are described in more detail.

First, in regard to an antenna port, the antenna port is defined so that a channel over which a symbol on an antenna port is conveyed may be inferred from a channel over which another symbol on the same antenna port is conveyed. When large-scale properties of a channel over which a symbol on one antenna port is conveyed may be inferred from a channel over which a symbol on another antenna port is conveyed, the two antenna ports may be regarded as being in a quasi co-located or quasi co-location (QC/QCL) relation. Here, the large-scale properties may include at least one of delay spread, Doppler spread, frequency shift, average received power, and received timing.

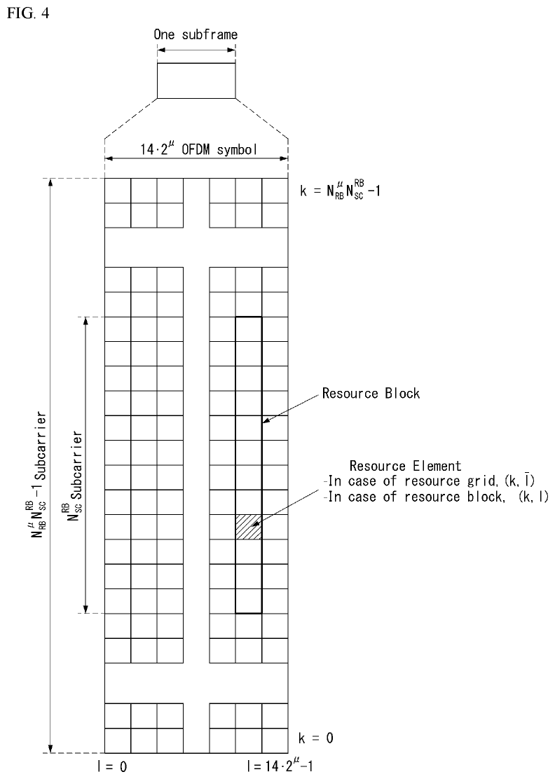

FIG. 4 illustrates an example of a resource grid supported in a wireless communication system to which a method proposed in the present invention is applicable.

Referring to FIG. 4, a resource grid consists of N_{RB}^{μ}N_{sc}^{RB} subcarriers on a frequency domain, each subframe consisting of 14·2^{μ} OFDM symbols, but the present invention is not limited thereto.

In the NR system, a transmitted signal is described by one or more resource grids, consisting of N_{RB}^{μ}N_{sc}^{RB} subcarriers, and 2^{μ}N_{symb}^{(μ)} OFDM symbols, where N_{RB}^{μ}≤N_{RB}^{max,μ}. N_{RB}^{max,μ} denotes a maximum transmission bandwidth and may change not only between numerologies but also between uplink and downlink

In this case, as illustrated in FIG. 5, one resource grid may be configured per numerology μ and antenna port p.

FIG. 5 illustrates examples of a resource grid per antenna port and numerology to which a method proposed in the present invention is applicable.

Each element of the resource grid for the numerology μ and the antenna port p is called a resource element and is uniquely identified by an index pair (k,l̅), where k=0, . . . , N_{RB}^{μ}N_{sc}^{RB}−1 is an index on a frequency domain, and l̅=0, . . . , 2^{μ}N_{symb}^{(μ)}−1 refers to a location of a symbol in a subframe. The index pair (k,l) is used to refer to a resource element in a slot, where l=0, . . . , N_{symb}^{μ}−1.

The resource element (k,l̅) for the numerology μ and the antenna port p corresponds to a complex value a_{k,l̅}^{(p,μ)}. When there is no risk for confusion or when a specific antenna port or numerology is not specified, the indices p and μ may be dropped, and as a result, the complex value may be a_{k,l̅}^{(p)} or a_{k,l̅}.

Further, a physical resource block is defined as N_{sc}^{RB}=12 consecutive subcarriers in the frequency domain.

Point A serves as a common reference point of a resource block grid and may be obtained as follows.

offsetToPointA for PCell downlink represents a frequency offset between the point A and a lowest subcarrier of a lowest resource block that overlaps a SS/PBCH block used by the UE for initial cell selection, and is expressed in units of resource blocks assuming 15 kHz subcarrier spacing for FR1 and 60 kHz subcarrier spacing for FR2;

absoluteFrequencyPointA represents frequency-location of the point A expressed as in absolute radio-frequency channel number (ARFCN).

The common resource blocks are numbered from 0 and upwards in the frequency domain for subcarrier spacing configuration μ.

The center of subcarrier 0 of common resource block 0 for the subcarrier spacing configuration μ coincides with ‘point A’. A common resource block number n_{CRB}^{μ} in the frequency domain and resource elements (k, l) for the subcarrier spacing configuration μ may be given by the following Equation 1.

$${n}_{CRB}^{μ} = ⌊ \frac{k}{{N}_{sc}^{RB}} ⌋ \qquad [ Equation 1 ]$$

Here, k may be defined relative to the point A so that k=0 corresponds to a subcarrier centered around the point A. Physical resource blocks are defined within a bandwidth part (BWP) and are numbered from 0 to N_{BWP,i}^{size}−1, where i is No. Of the BWP. A relation between the physical resource block n_{PRB} in BWP i and the common resource block n_{CRB} may be given by the following Equation 2.

n_{CRB}=n_{PRB}+N_{BWP,i}^{start} [Equation 2]

Here, N_{BWP,i}^{start}, may be the common resource block where the BWP starts relative to the common resource block 0.

Physical Channel and General Signal Transmission

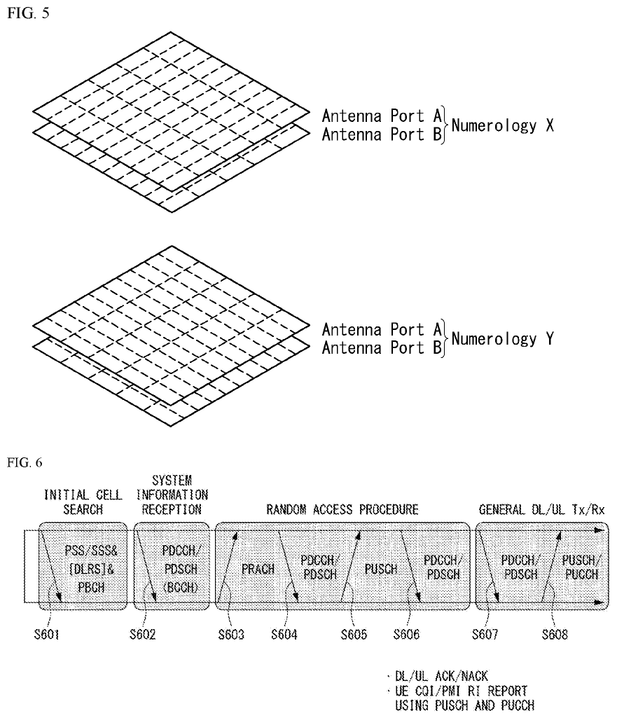

FIG. 6 illustrates physical channels and general signal transmission used in a 3GPP system. In a wireless communication system, the UE receives information from the eNB through Downlink (DL) and the UE transmits information from the eNB through Uplink (UL). The information which the eNB and the UE transmit and receive includes data and various control information and there are various physical channels according to a type/use of the information which the eNB and the UE transmit and receive.

When the UE is powered on or newly enters a cell, the UE performs an initial cell search operation such as synchronizing with the eNB (S601). To this end, the UE may receive a Primary Synchronization Signal (PSS) and a (Secondary Synchronization Signal (SSS) from the eNB and synchronize with the eNB and acquire information such as a cell ID or the like. Thereafter, the UE may receive a Physical Broadcast Channel (PBCH) from the eNB and acquire in-cell broadcast information. Meanwhile, the UE receives a Downlink Reference Signal (DL RS) in an initial cell search step to check a downlink channel status.

A UE that completes the initial cell search receives a Physical Downlink Control Channel (PDCCH) and a Physical Downlink Control Channel (PDSCH) according to information loaded on the PDCCH to acquire more specific system information (S602).

Meanwhile, when there is no radio resource first accessing the eNB or for signal transmission, the UE may perform a Random Access Procedure (RACH) to the eNB (S603 to S606). To this end, the UE may transmit a specific sequence to a preamble through a Physical Random Access Channel (PRACH) (S603 and S605) and receive a response message (Random Access Response (RAR) message) for the preamble through the PDCCH and a corresponding PDSCH. In the case of a contention based RACH, a Contention Resolution Procedure may be additionally performed (S606).

The UE that performs the above procedure may then perform PDCCH/PDSCH reception (S607) and Physical Uplink Shared Channel (PUSCH)/Physical Uplink Control Channel (PUCCH) transmission (S608) as a general uplink/downlink signal transmission procedure. In particular, the UE may receive Downlink Control Information (DCI) through the PDCCH. Here, the DCI may include control information such as resource allocation information for the UE and formats may be differently applied according to a use purpose.

Meanwhile, the control information which the UE transmits to the eNB through the uplink or the UE receives from the eNB may include a downlink/uplink ACK/NACK signal, a Channel Quality Indicator (CQI), a Precoding Matrix Index (PMI), a Rank Indicator (RI), and the like. The UE may transmit the control information such as the CQI/PMI/RI, etc., through the PUSCH and/or PUCCH.

CSI Related Operation

In a New Radio (NR) system, a channel state information-reference signal (CSI-RS) is used for time and/or frequency tracking, CSI computation, layer 1 (L1)-reference signal received power (RSRP) computation, and mobility. The CSI computation is related to CSI acquisition and L1-RSRP computation is related to beam management (BM).

Channel state information (CSI) collectively refers to information that may indicate the quality of a wireless channel (or referred to as a link) formed between the UE and the antenna port.

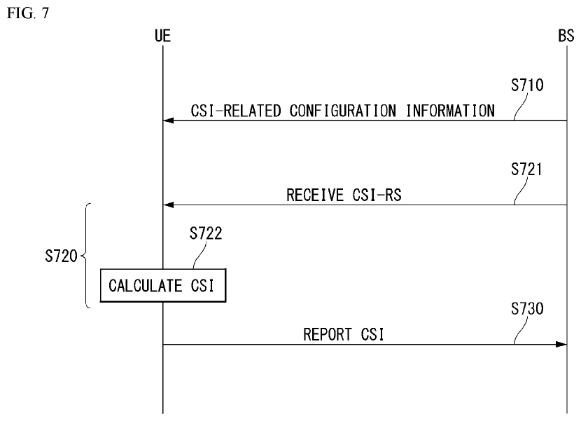

FIG. 7 is a flowchart showing an example of a CSI associated procedure to which a method proposed in the present invention may be applied.

Referring to FIG. 7, in order to perform one of usages of the CSI-RS, a terminal (e.g., user equipment (UE)) receives, from a base station (e.g., general Node B or gNB), configuration information related to the CSI through radio resource control (RRC) signaling (S710).

The configuration information related to the CSI may include at least one of CSI-interference management (IM) resource related information, CSI measurement configuration related information, CSI resource configuration related information, CSI-RS resource related information, or CSI reporting configuration related information.

The CSI-IM resource related information may include CSI-IM resource information, CSI-IM resource set information, and the like. The CSI-IM resource set is identified by a CSI-IM resource set identifier (ID) and one resource set includes at least one CSI-IM resource. Each CSI-IM resource is identified by a CSI-IM resource ID.

The CSI resource configuration related information defines a group including at least one of a non zero power (NZP) CSI-RS resource set, a CSI-IM resource set, or a CSI-SSB resource set. In other words, the CSI resource configuration related information may include a CSI-RS resource set list and the CSI-RS resource set list may include at least one of a NZP CSI-RS resource set list, a CSI-IM resource set list, or a CSI-SSB resource set list. The CSI-RS resource set is identified by a CSI-RS resource set ID and one resource set includes at least one CSI-RS resource. Each CSI-RS resource is identified by a CSI-RS resource ID.

Table 5 shows an example of NZP CSI-RS resource set IE. As shown in Table 5, parameters (e.g., a BM related ‘repetition’ parameter and a tracking related ‘trs-Info’ parameter) representing the usage may be configured for each NZP CSI-RS resource set.

```
TABLE 5
  -- ASN1START
  -- TAG-NZP-CSI-RS-RESOURCESET-START
```

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1 . .maxNrofNZP-CSI-RS- |

ResourcesPerSet) ) OF NZP-CSI-RS-ResourceId,

| | |
|---|---|
| repetition | ENUMERATED ( on, off ) |
| aperiodicTriggeringOffset | INTEGER (0 . . 4) |
| trs-Info | ENUMERATED (true) |
| . . . | |
| } | |
| -- TAG-NZP-CSI-RESOURCESET-STOP | |
| -- ASN1STOP | |

In addition, the repetition parameter corresponding to the higher layer parameter corresponds to ‘CSI-RS-ResourceRep’ of L1 parameter.

The CSI reporting configuration related information includes a reportConfigType parameter representing a time domain behavior and a reportQuantity parameter representing a CSI related quantity for reporting. The time domain behavior may be periodic, aperiodic, or semi-persistent.

The CSI reporting configuration related information may be expressed as CSI-ReportConfig IE and Table 9 below shows an example of CSI-ReportConfig IE.

```
TABLE 6
  -- ASN1START
  -- TAG-CSI-RESOURCECONFIG-START
```

| CSI-ReportConfig ::= | SEQUENCE { | |
|---|---|---|
| reportConfigId | CSI-ReportConfigId, | |
| carrier | ServCellIndex | OPTIONAL, - |
| - Need S | | |
| resourcesForChannelMeasurement | CSI-ResourceConfigId, | |
| csi-IM-ResourcesForInterference | CSI-ResourceConfigId | OPTIONAL, - |
| - Need R | | |
| nzp-CSI-RS-ResourcesForInterference | CSI-ResourceConfigId | OPTIONAL, - |

| | |
|---|---|
| - Need R | |
| reportConfigType | CHOICE { |
| periodic | SEQUENCE { |
| reportSlotConfig | CSI- |
| ReportPeriodicityAndOffset, | |
| pucch-CSI-ResourceList | SEQUENCE (SIZE |
| (1 . .maxNrofBWPs)) OF PUCCH-CSI-Resource | |
| }, | |
| semiPersistentOnPUCCH | SEQUENCE { |
| reportSlotConfig | CSI- |
| ReportPeriodicityAndOffset, | |
| pucch-CSI-ResourceList | SEQUENCE (SIZE |
| (1 . .maxNrofBWPs)) OF PUCCH-CSI-Resource | |
| }, | |
| semiPersistentOnPUSCH | SEQUENCE { |
| reportSlotConfig | ENUMERATED {s15, s110, s120, |
| s140, s180, s1160, s1320}, | |
| reportSlotOffsetList | SEQUENCE (SIZE (1 . . maxNrofUL- |
| Allocations)) OF INTEGER(0 . . 32), | |
| p0alpha | P0-PUSCH-AlphaSetId |
| }, | |
| aperiodic | SEQUENCE |
| reportSlotOffsetList | SEQUENCE (SIZE (1..maxNrofUL- |
| Allocations)) OF INTEGER(0 . . 32) | |
| } | |
| }, | |
| reportQuantity | CHOICE { |
| none | NULL, |
| cri-RI-PMI-CQI | NULL, |
| cri-RI-i1 | NULL, |
| cri-RI-i1-CQI | SEQUENCE ( |
| pdsch-BundleSizeForCSI | ENUMERATED {n2, n4} |
| OPTIONAL | |
| }, | |
| cri-RI-CQI | NULL, |
| cri-RSRP | NULL, |
| ssb-Index-RSRP | NULL, |
| cri-RI-LI-PMI-CQI | NULL |
| }, | |

The UE measures CSI based on configuration information related to the CSI (S720). The CSI measurement may include (1) a CSI-RS reception process (S721) and (2) a process of computing the CSI through the received CSI-RS (S722). And, detailed descriptions thereof will be described later.

For the CSI-RS, resource element (RE) mapping is configured time and frequency domains by higher layer parameter CSI-RS-ResourceMapping.

Table 7 shows an example of CSI-RS-ResourceMapping IE.

```
TABLE 7
    -- ASN1START
  -- TAG-CSI-RS-RESOURCEMAPPING-START
```

| | |
|---|---|
| CSI-RS-ResourceMapping ::= | SEQUENCE { |
| frequencyDomainAllocation | CHOICE { |
| row1 | BIT STRING (SIZE (4)), |
| row2 | BIT STRING (SIZE (12)), |
| row4 | BIT STRING (SIZE (3)), |
| other | BIT STRING(SIZE (6)) |
| }, | |
| nrofPorts | ENUMERATED (p1,p2,p4,p8,p12,p16,p24,p32), |
| firstOFDMSymbolInTimeDomain | INTEGER (0 . . 13), |
| firstOFDMSymbolInTimeDomain2 | INTEGER (2 . . 12) |
| cdm-Type | ENUMERATED {noCDM, fd-CDM2, cdm4-FD2-TD2, cdm8- |
| FD2-TD4), | |
| density | CHOICE { |
| dot5 | ENUMERATED {evenPRBs, odddPRBs }, |
| one | NULL, |
| three | NULL, |
| spare | NULL |
| }, | |
| freqBand | CSI-FrequencyOccupation |
| . . . | |
| } | |

In Table 7, a density (D) represents a density of the CSI-RS resource measured in RE/port/physical resource block (PRB) and nrofPorts represents the number of antenna ports.

The UE reports the measured CSI to the eNB (S730).

Here, in the case where a quantity of CSI-ReportConfig of Table 7 is configured to ‘none (or No report)’, the UE may skip the report.

However, even in the case where the quantity is configured to ‘none (or No report)’, the UE may report the measured CSI to the eNB.

The case where the quantity is configured to ‘none (or No report)’ is a case of triggering aperiodic TRS or a case where repetition is configured.

Here, only in a case where the repetition is configured to ‘ON’, the UE may be skip the report.

CSI Measurement

The NR system supports more flexible and dynamic CSI measurement and reporting.

The CSI measurement may include a procedure of acquiring the CSI by receiving the CSI-RS and computing the received CSI-RS.

As time domain behaviors of the CSI measurement and reporting, aperiodic/semi-persistent/periodic channel measurement (CM) and interference measurement (IM) are supported.

A 4 port NZP CSI-RS RE pattern is used for configuring the CSI-IM.

CSI-IM based IMR of the NR has a similar design to the CSI-IM of the LTE and is configured independently of ZP CSI-RS resources for PDSCH rate matching.

In addition, in ZP CSI-RS based IMR, each port emulates an interference layer having (a preferable channel and) precoded NZP CSI-RS.

This is for intra-cell interference measurement with respect to a multi-user case and primarily targets MU interference.

The eNB transmits the precoded NZP CSI-RS to the UE on each port of the configured NZP CSI-RS based IMR.

The UE assumes a channel/interference layer for each port and measures interference.

In respect to the channel, when there is no PMI and RI feedback, multiple resources are configured in a set and the base station or the network indicates a subset of NZP CSI-RS resources through the DCI with respect to channel/interference measurement.

Resource setting and resource setting configuration will be described in more detail.

Resource Setting

Each CSI resource setting ‘CSI-ResourceConfig’ includes a configuration for S≥1 CSI resource set (given by higher layer parameter csi-RS-ResourceSetList).

Here, the CSI resource setting corresponds to the CSI-RS-resourcesetlist.

Here, S represents the number of configured CSI-RS resource sets.

Here, the configuration for S≥1 CSI resource set includes each CSI resource set including CSI-RS resources (constituted by NZP CSI-RS or CSI IM) and an SS/PBCH block (SSB) resource used for L1-RSRP computation.

Each CSI resource setting is positioned in a DL BWP (bandwidth part) identified by a higher layer parameter bwp-id.

In addition, all CSI resource settings linked to CSI reporting setting have the same DL BWP.

A time domain behavior of the CSI-RS resource within the CSI resource setting included in CSI-ResourceConfig IE is indicated by higher layer parameter resourceType and may be configured to be aperiodic, periodic, or semi-persistent.

The number S of configured CSI-RS resource sets is limited to ‘1’ with respect to periodic and semi-persistent CSI resource settings.

Periodicity and slot offset which are configured are given in numerology of associated DL BWP as given by bwp-id with respect to the periodic and semi-persistent CSI resource settings.

When the UE is configured as multiple CSI-ResourceConfigs including the same NZP CSI-RS resource ID, the same time domain behavior is configured with respect to CSI-ResourceConfig.

When the UE is configured as multiple CSI-ResourceConfigs including the same CSI-IM resource ID, the same time domain behavior is configured with respect to CSI-ResourceConfig.

Next, one or more CSI resource settings for channel measurement (CM) and interference measurement (IM) are configured through higher layer signaling.

CSI-IM resource for interference measurement.

NZP CSI-RS resource for interference measurement.

NZP CSI-RS resource for channel measurement. That is, channel measurement resource (CMR) may be NZP CSI-RS and interference measurement resource (IMR) may be NZP CSI-RS for CSI-IM and IM.

Here, CSI-IM (or ZP CSI-RS for IM) is primarily used for inter-cell interference measurement.

In addition, NZP CSI-RS for IM is primarily used for intra-cell interference measurement from multi-users.

The UE may assume CSI-RS resource(s) for channel measurement and CSI-IM/NZP CSI-RS resource(s) for interference measurement configured for one CSI reporting are ‘QCL-TypeD’ for each resource.

Resource Setting Configuration

As described, the resource setting may mean a resource set list.

In each trigger state configured by using higher layer parameter CSI-AperiodicTriggerState with respect to aperiodic CSI, each CSI-ReportConfig is associated with one or multiple CSI-ReportConfigs linked to the periodic, semi-persistent, or aperiodic resource setting.

One reporting setting may be connected with a maximum of three resource settings.

When one resource setting is configured, the resource setting (given by higher layer parameter resourcesForChannelMeasurement) is used for channel measurement for L1-RSRP computation.

When two resource settings are configured, a first resource setting (given by higher layer parameter resourcesForChannelMeasurement) is used for channel measurement and a second resource setting (given by csi-IM-ResourcesForlnterference or nzp-CSI-RS-ResourcesForInterference) is used for interference measurement performed on CSI-IM or NZP CSI-RS.

When three resource settings are configured, a first resource setting (given by resourcesForChannelMeasurement) is for channel measurement, a second resource setting (given by csi-IM-ResourcesForlnterference) is for CSI-IM based interference measurement, and a third resource setting (given by nzp-CSI-RS-ResourcesForInterference) is for NZP CSI-RS based interference measurement.

Each CSI-ReportConfig is linked to periodic or semi-persistent resource setting with respect to semi-persistent or periodic CSI.

When one resource setting (given by resourcesForChannelMeasurement) is configured, the resource setting is used for channel measurement for L1-RSRP computation.

When two resource settings are configured, a first resource setting (given by resourcesForChannelMeasurement) is used for channel measurement and a second resource setting (given by higher layer parameter csi-IM-ResourcesForlnterference) is used for interference measurement performed on CSI-IM.

CSI Computation

When interference measurement is performed on CSI-IM, each CSI-RS resource for channel measurement is associated with the CSI-IM resource for each resource by an order of CSI-RS resources and CSI-IM resources within a corresponding resource set. The number of CSI-RS resources for channel measurement is equal to the number of CSI-IM resources.

In addition, when the interference measurement is performed in the NZP CSI-RS, the UE does not expect to be configured as one or more NZP CSI-RS resources in the associated resource set within the resource setting for channel measurement.

A UE in which Higher layer parameter nzp-CSI-RS-ResourcesForInterference is configured does not expect that 18 or more NZP CSI-RS ports will be configured in the NZP CSI-RS resource set.

For CSI measurement, the UE assumes the followings.

Each NZP CSI-RS port configured for interference measurement corresponds to an interference transport layer.

In all interference transport layers of the NZP CSI-RS port for interference measurement, an energy per resource element (EPRE) ratio is considered.

Different interference signals on RE(s) of the NZP CSI-RS resource for channel measurement, the NZP CSI-RS resource for interference measurement, or CSI-IM resource for interference measurement.

CSI Reporting

For CSI reporting, time and frequency resources which may be used by the UE are controlled by the eNB.

The channel state information (CSI) may include at least one of a channel quality indicator (CQI), a precoding matrix indicator (PMI), a CSI-RS resource indicator (CRI), an SS/PBCH block resource indicator (SSBRI), a layer indicator (LI), a rank indicator (RI), and L1-RSRP.

For the CQI, PMI, CRI, SSBRI, LI, RI, and L1-RSRP, the UE is configured by a higher layer as N≥1 CSI-ReportConfig reporting setting, M≥1 CSI-ResourceConfig resource setting, and a list (provided by aperiodicTriggerStateList and semiPersistentOnPUSCH) of one or two trigger states. In the aperiodicTriggerStateList, each trigger state includes the channel and an associated CSI-ReportConfigs list optionally indicating resource set IDs for interference. In the semiPersistentOnPUSCH-TriggerStateList, each trigger state includes one associated CSI-ReportConfig.

In addition, the time domain behavior of CSI reporting supports periodic, semi-persistent, and aperiodic.

i) The periodic CSI reporting is performed on short PUCCH and long PUCCH. The periodicity and slot offset of the periodic CSI reporting may be configured through RRC and refer to the CSI-ReportConfig IE.
ii) SP CSI reporting is performed on short PUCCH, long PUCCH, or PUSCH.

In the case of SP CSI on the short/long PUCCH, the periodicity and the slot offset are configured as the RRC and the CSI reporting to separate MAC CE/DCI is activated/deactivated.

In the case of the SP CSI on the PUSCH, the periodicity of the SP CSI reporting is configured through the RRC, but the slot offset is not configured through the RRC and the SP CSI reporting is activated/deactivated by DCI (format 0_1). Separated RNTI (SP-CSI C-RNTI) is used with respect to the SP CSI reporting on the PUSCH.

An initial CSI reporting timing follows a PUSCH time domain allocation value indicated in the DCI and a subsequent CSI reporting timing follows a periodicity configured through the RRC.

DCI format 0_1 may include a CSI request field and may activate/deactivate a specific configured SP-CSI trigger state. SP CSI reporting has activation/deactivation which is the same as or similar to a mechanism having data transmission on SPS PUSCH.

iii) aperiodic CSI reporting is performed on a PUSCH and triggered by DCI. In this case, information related to trigger of aperiodic CSI reporting may be transferred/instructed/configured through MAC-CE.

In the case of AP CSI having an AP CSI-RS, AP CSI-RS timing is set by RRC, and timing for AP CSI reporting is dynamically controlled by DCI.

The NR does not adopt a scheme (for example, transmitting RI, WB PMI/CQI, and SB PMI/CQI in order) of dividing and reporting the CSI in multiple reporting instances applied to PUCCH-based CSI reporting in the LTE. Instead, the NR restricts specific CSI reporting not to be configured in the short/long PUCCH and a CSI omission rule is defined. In addition, in relation with the AP CSI reporting timing, a PUSCH symbol/slot location is dynamically indicated by the DCI. In addition, candidate slot offsets are configured by the RRC. For the CSI reporting, slot offset(Y) is configured for each reporting setting. For UL-SCH, slot offset K2 is configured separately.

Two CSI latency classes (low latency class and high latency class) are defined in terms of CSI computation complexity. The low latency CSI is a WB CSI that includes up to 4 ports Type-I codebook or up to 4-ports non-PMI feedback CSI. The high latency CSI refers to CSI other than the low latency CSI. For a normal UE, (Z, Z′) is defined in a unit of OFDM symbols. Here, Z represents a minimum CSI processing time from the reception of the aperiodic CSI triggering DCI to the execution of the CSI reporting. And, Z′ represents a minimum CSI processing time from the reception of the CSI-RS for channel/interference to the execution of the CSI reporting.

Additionally, the UE reports the number of CSIs which may be simultaneously calculated.

Table 8 below relates to CSI reporting configuration defined in TS38.214.

TABLE 8
5.2.1.4 Reporting configurations
The UE shall calculate CSI parameters (if reported) assuming the following
dependencies between CSI parameters (if reported)
LI shall be calculated conditioned on the reported CQI, PMI, RI and CRI
CQI shall be calculated conditioned on the reported PMI, RI and CRI
PMI shall be calculated conditioned on the reported RI and CRI
RI shall be calculated conditioned on the reported CRI.
The Reporting configuration for CSI can be aperiodic (using PUSCH), periodic
(using PUCCH) or semi-persistent (using PUCCH, and DCI activated PUSCH). The CSI-RS
Resources can be periodic, semi-persistent, or aperiodic. Table 5.2.1.4-1 shows the supported
combinations of CSI Reporting configurations and CSI-RS Resources configurations and
how the CSI Reporting is triggered for each CSI-RS Resources configuration.
Periodic CSI-RS is configured by higher layers. Semi-persistent CSI-RS is activated and
deactivated as described in Subclause 5.2.1.5.2. Aperiodic CSI-RS is configured and
triggered/activated as described in Subclause 5.2.1.5.1.
Table 5.2.1.4-1: Triggering/Activation of CSI Reporting for the possible CSI-RS Configurations.

| CSI-RS | Periodic CSI | Semi-Persistent | Aperiodic CSI |
|---|---|---|---|
| Configuration | Reporting | CSI Reporting | Reporting |
| Periodic CSI-RS | No dynamic | For reporting | Triggered by |
| | triggering/activation | on PUCCH, the UE | DCI; additionally, |
| | | receives an | activation command |
| | | activation command | [10, TS 38.321] |
| | | [10, TS 38.321]; for | possible as defined |
| | | reporting on PUSCH, | in Subclause |
| | | the UE receives | 5.2.1.5.1. |
| | | triggering on DCI | |
| Semi-Persistent | Not Supported | For reporting | Triggered by |
| CSI-RS | | on PUCCH, the UE | DCI; additionally, |
| | | receives an | activation command |
| | | activation command | [10, TS 38.321] |
| | | [10, TS 38.321]; for | possible as defined |
| | | reporting PUSCH, | in Subclause |
| | | the UE receives | 5.2.1.5.1. |
| | | triggering on DCI | |
| Aperiodic CSI-RS | Not Supported | Not Supported | Triggered by |
| | | | DCI; additionally, |
| | | | activation command |
| | | | [10, TS 38.321] |
| | | | possible as defined |
| | | | in Subclause |
| | | | 5.2.1.5.1. |

In addition, Table 9 below is information related to activation/deactivation/trigger by MAC-CE related to semi-persistent/aperiodic CSI reporting defined in TS38.321.

TABLE 9
5.18.2 Activation/Deactivaton of Semi-persistent CSI-RS/CSI-IM resource set
The network may activate and deactivated the configured Semi-peristent CSI-RS/CSI-IM
resource sets of a Serving Cell by sending the SP CSI-RS/CSI-IM Resource Set
Activation/Deactivation MAC CE described in subclause 6.1.3.12. The configured
Semi-persistent CSI-RS/CSI-IM resource sets are initially deactivated upon
configuration and after a handover.
The MAC entity shall:
1> if the MAC entity receives an SP CSI-RS/CSI-IM Resource Set
Activation/Deactivation MAC CE on a Serving Cell:
2> indicate to lower layers the information regarding the SP CSI-RS/CSI-IM Resource Set
Activation/Deactivation MAC CE.
5.18.3 Aperiodic CSI Trigger State subselection
The network may select among the configured aperiodic CSI trigger states of a Serving
Cell by sending the Aperiodic CSI Trigger State Subselection MAC CE described in
subclause 6.1.3.13.
The MAC entitiy shall:
1> if the MAC entitiy receives an Aperiodic CSI gtrigger State
Subselection MAC CE on a Serving Cell:
2> indicate the lower layers the information regarding Aperiodic CSI trigger State
Subselection MAC CE.

CSI Reporting Using PUSCH

Aperiodic CSI reporting performed in a PUSCH supports wideband and subband frequency fragmentation. Aperiodic CSI reporting performed in the PUSCH supports type I and type II CSI.

The SP CSI reporting for PUSCH supports type I and type II CSI with wideband and subband frequency granularity. PUSCH resources for SP CSI reporting and modulation and coding scheme (MCS) are allocated semi-permanently by UL DCI.

The CSI reporting for the PUSCH may include part 1 and part 2. Part 1 is used to identify the number of bits of information in Part 2. Part 1 is delivered completely before Part 2.
Regarding type I CSI feedback, Part 1 includes RI (if reported), CRI (if reported), and CQI of a first codeword. Part 2 includes PMI, and when RI>4, Part 2 includes CQI.
For Type II CSI feedback, Part 1 has a fixed payload size and includes an indication (NIND) indicating the number of non-zero broadband amplitude coefficients for each layer of RI, CQI and Type II CSI. Part 2 includes a PMI of type II CSI. Part 1 and Part 2 are encoded independently.

When the CSI reporting includes two parts in the PUSCH and the CSI payload is smaller than a payload size provided by the PUSCH resource allocated for CSI reporting, the UE may omit a part of the second CSI. The omission of Part 2 CSI is determined according to priority shown in Table 10, in which priority 0 is the highest priority and 2N_{Rep} is the lowest priority. Here, N_{Rep} represents the number of CSI reporting in one slot.

TABLE 10

Priority 0.
Part 2 wideband CSI for CSI reports 1 to N_{Rep}
Priority 1.:
Part 2 subband CSI of even subbands for CSI report 1
Priority 2:
Part 2 subband CSI of odd subbands for CSI report 1
Priority 3.:
Part 2 subband CSI of even subbands for CSI report 2
Priority 4:
Part 2 subband CSI of odd subb ands for CSI report 2
.
.
.
Priority 2_{NRep}-1:
Part 2 subband CSI of even subbands for CSI report N_{Rep}
Priority 2_{NRep}:
Part 2 subband CSI of odd subb ands for CSI report N_{Rep}

When Part 2 CSI information for a specific priority level is omitted, the UE omits all information of the corresponding priority level.

When the UE is scheduled to transmit a transport block on a PUSCH multiplexed with CSI reporting, Part 2 CSI is omitted only when a UCI code rate for transmitting all Part 2 is greater than a threshold code rate

$${c}_{T} = \frac{{c}_{MCS}}{{β}_{offset}^{CSI \text{-} 2}} .$$

Here, c_{MCS} denotes a target PUSCH code rate, and β_{offset}^{CSI-2} denotes a CSI offset value.

Part 2 CSI is omitted level by level, starting from the lowest priority level, until the UCI code rate for the lowest priority level is smaller than or equal to c_{T}.

When the Part 2 CSI is transmitted on a PUSCH without a transport block, lower priority bits are omitted until the Part 2 CSI code rate is less than a threshold code rate

$${c}_{T} = \frac{{β}_{offset}^{CSI \text{-} part 1}}{{β}_{offset}^{CSI \text{-} part 2}} \cdot {r}_{CSI \text{-} 1}$$

lower than 1. Here, β_{offset}^{CSI-part1} and β_{offset}^{CSI-part2} represent CSI offset values, and r_{CSI-1} is based on a code rate calculated by the UE or signaled by DCI.

CSI Reporting Using PUCCH

A plurality of periodic CSI reporting corresponding to a CSI reporting configuration indication including one or more higher layers may be set in the UE. Here, an associated CSI measurement link and CSI resource configuration include higher layers.

Periodic CSI reporting in PUCCH format 2, 3 or 4 supports type I CSI based a wideband width.

Regarding SP CSI on a PUSCH, the UE transmits an HARQ-ACK corresponding to a PDSCH carrying a selection command in slot n, and then performs SP SCI reporting for the PUCCH in a slot n+3Nₛₗₒₜ^{subframe,μ}+1.

The selection command includes one or more report setting indications in which associated CSI resource setting is configured.

The SP CSI reporting supports type I CSI in PUCCH.

The SP CSI reporting of PUCCH format 2 supports type I CSI with wideband width frequency granularity. SP CSI reporting of PUCCH format 3 or 4 supports type I subband CSI and type II CSI with wideband width granularity.

When the PUCCH carries type I CSI with wideband width frequency granularity, CSI payloads carried by PUCCH format 2 and PUCCH format 3 or 4 are the same as CRI (when reported) regardless of RI.

In PUCCH format 3 or 4, the type I CSI subband payload is divided into two parts.

A first part (Part 1) includes an RI, a (reported) CRI, and a (reported) CQI of a first codeword. A second part (Part 2) includes a PMI, and when RI>4, the second part (Part 2) includes a CQI of a second codeword.

SP CSI reporting performed in PUCCH format 3 or 4 supports type II CSI feedback, but supports only part 1 of type II CSI feedback.

In PUCCH format 3 or 4 supporting type II CSI feedback, CSI reporting may depend on UE performance.

The type II CSI reporting delivered in PUCCH format 3 or 4 (Part 1 only) is calculated independently from the type II CSI reporting performed in the PUSCH.

When the UE is configured with CSI reporting in PUCCH format 2, 3 or 4, each PUCCH resource is configured for each candidate UL BWP.

If the UE has received the active SP CSI reporting configuration from the PUCCH and has not received a deactivation command, the CSI reporting is performed if a CSI reported BWP is an active BWP, and otherwise, the CSI reporting is temporarily stopped. This operation is also applied to the case of SP CSI of the PUCCH. For the PUSCH-based SP CSI reporting, the corresponding CSI reporting is automatically deactivated when BWP switching occurs.

Depending on a length of the PUCCH transmission, a PUCCH format may be classified into a short PUCCH or a long PUCCH. PUCCH formats 0 and 2 may be referred to as a short PUCCH, and PUCCH formats 1, 3 and 4 may be referred to as a long PUCCH.

For PUCCH-based CSI reporting, short PUCCH-based CSI reporting and long PUCCH-based CSI reporting will be described in detail below.

The short PUCCH-based CSI reporting is used only for wideband CSI reporting. The short PUCCH-based CSI reporting has the same payload regardless of RI/CRI of a slot given to avoid blind decoding.

A size of information payload may be different between maximum CSI-RS ports of a CSI-RS configured in a CSI-RS resource set.

When a payload including a PMI and a CQI is diversified to include an RI/CQI, padding bits are added to RI/CRI/PMI/CQI before an encoding procedure for equalizing a payload associated with other RI/CRI values. In addition, RI/CRI/PMI/CQI may be encoded with padding bits as necessary.

In the case of wideband reporting, the long PUCCH-based CSI reporting may use the same solution as that of the short PUCCH-based CSI reporting.

The long PUCCH-based CSI reporting uses the same payload regardless of RI/CRI. In the case of subband reporting, two-part encoding (for type I) is applied.

Part 1 may have a fixed payload according to the number of ports, a CSI type, RI restrictions, and the like, and Part 2 may have various payload sizes according to Part 1.

The CSI/RI may be first encoded to determine a payload of the PMI/CQI. In addition, CQIi (i=1,2) corresponds to a CQI for the i-th codeword (CW).

For a long PUCCH, Type II CSI reporting may only deliver Part 1.

The above contents (e.g., 3GPP system, CSI-related operation, etc.) may be applied in combination with the methods proposed in the present disclosure or may be supplemented to clarify technical characteristics of the methods proposed in the present disclosure. In addition, in this disclosure, ‘/’ may mean that all contents separated by/are included (and) or only some of the separated contents (or). In addition, in the present disclosure, the following terms are used uniformly for convenience of description.

<Contents Related to CSI Reporting Based on Type II CSI Codebook>

In the wireless communication environment described above, a high resolution feedback method such as linear combination (LC), covariance matrix feedback, and the like is considered for accurate and efficient feedback of channel state information (CSI) in terms of accurate and feedback overhead. In particular, in a new RAT (NR) system, in case of the Type II CSI feedback, a ‘DFT-based compression’ method described in Table 11 is considered as a method of combining beams by subband (SB) width for W₁ including L orthogonal DFT beams corresponding to wideband (WB) information.

Table 11 shows an example of the DFT-based compression method in terms of reducing a CSI reporting overhead based on the Type II CSI codebook of Rank 1-2.

TABLE 11
DFT-based compression

```
— Precoders for a layer is given by size-P × N₃ matrix W = W₁\tilde{W}₂W_{f}^{H}
  — P = 2N₁N₂ = #SD dimensions
    N₃ = #FD dimensions
    — FFS value and unit of N₃
  — Precoder normalization: the precoding matrix for given rank and unit of N₃ is normalized
    to norm 1/sqrt(rank)
— Spatial domain (SD) compression
  — L spatial domain basis vectors (mapped to the two polarizations, so 2L in total) selected
  $— Compression in spatial domain using {W}_{1} = [ \begin{matrix}{v}_{0} {v}_{1} … {v}_{L - 1} & 0 \\ 0 & {v}_{0} {v}_{1} … {v}_{L - 1}\end{matrix} ] ,$
    where {vᵢ}ᵢ₌₀^{L-1} are N₁N₂ × 1 orthogonal DFT vectors (same as Rel. 15 Type II)
— Frequency-domain (FD) compression
  $— Compression via {W}_{f} = [ {W}_{f} ( 0 ) , … , {W}_{f} ( 2 L - 1 ) ] where {W}_{f} ( i ) = [ {f}_{{k}_{i , 0}} {f}_{{k}_{i , 1}} … {f}_{{k}_{i , {M}_{i} - 1}} ] ,$
    where {fₖ_{_{i,m}}}ₘ₌₀^{M}^{ᵢ}⁻¹ are Mᵢ size-N₃ × 1 orthogonal DFT vectors for SD-component
    i = 0, ...,2L − 1
    — Number of FD-componcnts {Mᵢ} or Σᵢ₌₀^{2L-1} Mᵢ is configurable, FFS value range
  — FFS: choose one of the following alternatives
    — Alt1. common basis vectors: W_{f} = [fₖ_{₀} fₖ_{₁} ...fₖ_{_{M−1}}], i.e. Mᵢ = M ∀i and
      {k_{i,m}}ₘ₌₀^{M}^{ᵢ}⁻¹ are identical (i.e., k_{i,m}=kₘ, i = 0, ...,2L − 1)
    — Alt2. independent basis vectors: W_{f} = [W_{f}(0), ... , W_{f}(2L − 1)], where W_{f}(i) =
    $— [ {f}_{{k}_{i , m}} {f}_{{k}_{i , 1}} … {f}_{{k}_{i , {M}_{i} - 1}} ] , i . c . {M}_{i} frequency \text{-} domain components ( per SD \text{-} component )$
    — are selected
    — Note: {kₘ}ₘ₌₀^{M-1} or {k_{i,m}}ₘ₌₀^{M}^{ᵢ}⁻¹, i = 0, ... ,2L − 1 are all selected from the index set
    — {0,1, ... , N₃ − 1) from the same orthogonal basis group
  — FFS: If oversampled DFT basis or DCT basis is used instead of orthogonal DFT basis
    FFS: Same or different FD-basis selection across layers
— Linear combination coefficients (for a layer)
  — FFS if \tilde{W}₂ is composed of K = 2LM or K = Σᵢ₌₀^{2L-1} Mᵢ linear combination coefficients
  — FFS if only a subset K₀ < K of coefficients are reported (coefficients not reported are zero).
  — FFS if layer compression is applied so that Σᵢ₌₀^{2L-l-1} Mᵢ transformed coefficients are used
    to construct \tilde{W}₂ for layer 1 (where the transformed coefficients are the reported quantity)
  — FFS quantization/encoding/reporting structure
  — Note: The terminology “SD-compression” and “FD-compression” are for discussion
    purposes only and are not intended to be captured in the specification
```

Also, a method of extending the DFT-based compression method to even a case of RI=3-4 is considered. Together with a consent that a maximum number of total non-zero (NZ) coefficients across all layers may be less than or equal to 2K₀, (here, the value K₀ (i.e., β) is set for RI∈{1,2}, the method of determining the number of non-zero (NZ) coefficients for each layer may be selected from the following examples (Alt 0/Alt 1).

Alt0. K_{NZ,i} is unrestricted as long as Σᵢ₌₀^{RI-1}K_{NZ,i}≤2K₀

Alt1. K_{NZ,i}≤K0 as long as Σᵢ₌₀^{RI-1}K_{NZ,i}≤2K₀

When a parameter p=v₀ for RI=3-4 is set as an higher layer together with a parameter p=v₀ for RI=1-2, Table 12 below may be supported.

The parameters (y₀, v₀) may be selected from

$$\{ ( \frac{1}{2} , \frac{1}{4} ) , ( \frac{1}{4} , \frac{1}{4} ) , ( \frac{1}{4} , \frac{1}{8} ) \} .$$

TABLE 12

| RI | Layer | L | p |
|---|---|---|---|
| 1 | 0 | x₀ | y₀ |
| 2 | 0 | | |
| | 1 | | |
| 3 | 0 | | v₀ |
| | 1 | | |
| | 2 | | |
| 4 | 0 | | |
| | 1 | | |
| | 2 | | |
| | 3 | | |

The above contents refers to expression of channel information by utilizing a basis or codebook for spatial domain (SD) and frequency domain (FD) information. The size of the reported total feedback is affected by the number of beams to be combined, the amount of quantization for combining coefficients, and subband size, and the like, and in CSI feedback, most payload occur when the UE reports the information of \tilde{W}₂ to the BS. Here, \tilde{W}₂ includes linear combination coefficients for an SD/FD codebook in the DFT-based compression method and may be represented by a matrix having a size of 2 L×M.

In particular, if a rank exceeds 1, an SD/FD compressed codebook for each layer needs to be specified separately, or even if the same codebook is applied to all layers, channel information is configured by overlapping \tilde{W}₂ for the codebook in an SD and an FD of each layer, and thus channel state information to be fed back as the rank increases also linearly increases.

In the NR, in the related art, in the case of CSI feedback of a single BS and a UE, such as CSI reporting using a PUSCH, CSI elements (or parameters) are divided into part 1 and part 2 so that they may be sent based on a feedback resource capacity allocated to the UCI and the requirements for the amount of UE CSI feedback resources are satisfied by omitting channel state information according to a priority level in each part.

However, unlike the related art method of reporting linear combination (LC) coefficients for a spatial domain beam for each subband (SB), the enhanced Type II CSI codebook newly considered in NR reports deformed LC coefficients based on compression in the frequency domain for the corresponding subbands. Therefore, since it is impossible to directly reuse the existing CSI omission operation, it is necessary to newly consider a CSI omission scheme according to the corresponding CSI codebook design.

<UCI Parameter Related Contents>

The UCI configuring the Type II CSI reporting may include parameters shown in Table 13.

Table 13 shows examples of parameters configuring UCI part 1 and part 2. UCI part 1 may refer to part 1 CSI, and UCI part 2 may refer to part 2 CSI.

TABLE 13

| Parameter | Location | Details/description |
|---|---|---|
| RI | UCI part 1 | RIϵ {1, . . . , RI_{MAX}} |
| # NZ coefficients | UCI part 1 | # NZC summed across layers, K_{NZTOT} ϵ {1, 2, . . . , 2K₀} |
| Wideband CQI | UCI part 1 | Same as R15 |
| Subband CQI | UCI part 1 | Same as R15 |
| Bitmap per layer | UCI part 2 | RI = 1-2: for layer l, size-2LM |
| | | RI = 3-4; for layer l, size-2LMᵢ-1 |
| Strongest coefficient | UCI part 2 | |
| indicator (SCI) | | |
| SD basis subset | UCI part 2 | Layer-common with combinatorial indicator |
| selection indicator | | |
| FD basis subset | UCI part 2 | |
| selection indicator | | |
| LC coefficients: phase | UCI part 2 | Quantized independently across layers |
| LC coefficients: | UCI part 2 | Quantized independently across layers (including reference |
| amplitude | | amplitude for weaker polarization, for each layer) |
| SD oversampling | UCI part 2 | Values of q₁, q₂ follow REl.15 |
| (rotation) factor q₁, q₂ | | |

Each parameter configuring the UCI will be described in detail.

RI(∈{1, . . . , RI_{MAX}}) and K_{NZ,TOT} (the total number of non-zero coefficients summed across all the layers, and here, K_{NZ,TOT} ∈{1,2, . . . , 2K₀}) is reported in UCI part 1.

At RI=3-4, each size of bitmaps is 2LMᵢ (i=0, 1, . . . , RI−1, where i represents the i-th layer) and is reported in UCI part 2.

The following FD basis subset selection scheme is supported:
At N3≤19, one-step free selection is used.
At N₃>19, Mᵢₙᵢₜᵢₐₗ fully parameterized with the window-based IntS indicates an intermediate set including FD bases mod(Mᵢₙᵢₜᵢₐₗ+n, N₃), n=0, 1, . . . , N₃′−1. N₃′=┌αM┐ where α is set to a higher layer from two possible values.
The second stage subset selection is indicated by X₂-bit combinatorial indicator (for each layer) in UCI part 2.

In SCI for RI=1, the strongest coefficient indicator (SCI) is a ┌log₂ K_{NZ}┐-bit indicator.

In SCI of RI>1 (reported in UCI part 2), SCI for each layer, i.e., SCIᵢ, is ┌log₂ 2L┐-bit (i=0, 1, . . . (RI−1)). A position (index) of the strongest LC coefficient of layer i before index remapping is (lᵢ*,mᵢ*), SCIᵢ=lᵢ*, and mᵢ* is not reported.

For SCI (RI>1) and FD basis subset selection indicator, the methods described in Table 14 below are supported.

TABLE 14

| | |
|---|---|
| SCI for RI > 1 | Alt3.4: Per-layer SCI, where SCIᵢ is a ┌log₂ 2L┐-bit (i=0,1,...(RI - 1)). The location |
| | (index) of the stongest LC coefficient for layer i before index remapping is (lᵢ*, mᵢ*), |
| | SCIᵢ=lᵢ*, and mᵢ* is not reported |
| Index remapping | For layer i, the index mᵢ of each nonzero LC coefficient Cₗ_{ᵢ},ₘ_{ᵢ} is remapped with respect |
| | to mᵢ* to \tilde{m}ᵢ such that \tilde{m}ᵢ* = 0 . The FD basis index kₘ_{ᵢ} associated to each nonzero |
| | LC coefficient [symbol] is remapped with respect to [symbol] to [symbol] such that [symbol] = 0. The |
| | sets { [symbol] ≠ [symbol] } and { [symbol] ≠ 0} are reported. |
| | Informative note (for the purpose of reference procedure): |
| | The index (lᵢ , mᵢ ) of nonzero LC coefficients is remapped as |
| | (lᵢ , mᵢ ) → (lᵢ ,(mᵢ − mᵢ*)mod Mᵢ). The codebook index associated with nonzero |
| | LC coefficient index (lᵢ , mᵢ ) is remapped as kₘ_{ᵢ} →(kₘ_{ᵢ} −kₘ_{ᵢ}*)modN₃. |
| Combinatorial indicator for N₃ ≤ 19 | $[ {log}_{2} ( \begin{matrix}{N}_{3} - 1 \\ {M}_{i} - 1\end{matrix} ) ] bits$ |
| Combinatorial indicator for N₃ > 19 | $[ {log}_{2} ( \begin{matrix}{N}_{3}^{′} - 1 \\ {M}_{i}^{′} - 1\end{matrix} ) ] - bits$ |
| Mᵢₙᵢₜᵢₐₗ | Reported in UCI part 2, details on bitwidth and possible values are FFS |

[symbol]

indicates data missing or illegible when filed

<CSI Omission Related Contents>

If uplink resources allocated for UCI are not sufficient for the entire CSI reporting, CSI omission may occur. CSI omission may also be referred to as UCI omission. When CSI omission occurs, the selected UCI omission scheme needs to meet the following criteria. i) CSI calculation is identical to a case without omission. Otherwise, the UE eventually recalculates the CSI when UCI omission occurs. When UCI omission occurs, a related CQI may not be calculated conditionally in a PMI after omission. ii) The occurrence of UCI omission may be inferred from associated CSI reporting without additional signaling. iii) Resultant UCI payload after omission should not be ambiguous (the BS should perform blind decoding of UCI part 2 due to payload ambiguity). iv) When CSI omission occurs, dropping all NZCs associated with any particular layer should not be done.

The non-zero LC coefficient (NZC) associated with the layer λe {0, 1, . . . , RI−1} beam l∈{0, 1, . . . , 2L−1}, and FD basis m∈{0, 1, . . . , M−1} may be represented by c_{l,m}^{(λ)}. The associated bitmap component (including 0) may be represented by β_{l,m}^{(λ)}.

For the purpose of omitting UCI, the parameters of UCI part 2 may be divided into 3 groups, and group (n) has higher priority than group (n+1) (n=0, 1).

When the UE is set to report N_{Rep} CSI reports, group 0 includes at least SD rotation factors, SD indicator, and SCI(s) for all N_{Rep} reports. For each of the N_{Rep} reports, group 1 may include at least a reference amplitude(s) for weaker polarization, {c_{l,m}^{(λ)}(λl,m)∈G₁}, and an FD indicator. For each of the N_{Rep} reports, group 2 includes at least {c_{l,m}^{(λ)}(λl,m)∈G₂}. Here, G1 and G2 exclude indices associated with the strongest coefficient(s).

Priority rules for determining G1 and G2 may be selected from Alt1.1 to Alt 1.3 below:

Alt 1.1: LC coefficients may be prioritized from high priority to low priority according to (λ,l,m). (index triplet, ┌K_{N2}^{TOT}/2┐, highest priority coefficients belong to G1, └K_{N2}^{TOT}/2┘ lowest priority coefficients belong to G2). Priority level may be calculated according to Prio(λ,l,m)=2L.RI. Perm₁(m)+RI. Perm₂(l)+λ.

Alt 1.2: Non-zero coefficients c_{l,m}^{(λ)} are sequentially sorted from 0 to KNZ-1 in order based on λ→l→m indexing (layer→SD→FD or based on l→λ→m indexing (SD→layer→FD). Group G1 includes at least first

$$\frac{{K}_{NZ}}{2}$$

sorted coefficients, and group G2 includes the remaining second sorted coefficients.

Alt 1.3: LC coefficients may be prioritized from high priority to low priority according to (λ,l,m) index triplet. ┌K_{N2}^{TOT}/2┐ highest priority coefficients belong to G1, and └K_{N2}^{TOT}/4L┘×2L lowest priority coefficients belong to G2. The priority level is calculated according to Prio(λ,l,m)=2L.RI. Perm₁(m)+RI. Perm₂(l)+λ.

To which group(s) β_{l,m}(λ) belongs is selected from the following (Alt 2.1 to Alt 2.6).

Alt 2.1: (only coupled with Alt 1.1) First

$$RI \cdot 2 LM - \frac{{K}_{NZ}^{TOT}}{2}$$

bits belong to group 1 according to Prio(λ,l,m), last

$$\frac{{K}_{NZ}^{TOT}}{2}$$

belongs to group 2 according to Prio(λ,l,m) value.

Alt 2.2: (only coupled with Alt 1.2) Bitmaps and coefficients are segmented into M segments (M=number of FD basis indices). Group 1 contains M1 segments and Group 2 contains M2 segments. Here, M=M1+M2.

Each segment includes bitmaps (sub-bitmaps) associated with all RI layers, all SD components and a single FD component and corresponding combination coefficients. A payload size of group 1 is given as

$$RI \cdot 2 LM + \frac{{K}_{NZ}^{TOT}}{2} N ( N = number of bits for amplitude and phase ) .$$

A payload size of group 2 is given as

$$\frac{{K}_{NZ}^{TOT}}{2} ( a + b ) .$$

Alt 2.3: (only coupled with Alt 1.3) First RI.2IM−└K_{NZ}^{TOT}/4L┘×2L bits belong to group 1 according to the value of Prio(λ,l,m), and last ┌K_{NZ}^{TOT}/4L┐×2L belongs to group 2 according to the value of Prio(λ,l,m).

Alt 2.4: (only coupled with Alt 1.1) The first RI.LM bits belong to group 1 according to the value of Prio(λ,l,m), and the last RI.LM belongs to group 2 according to the value of Prio(λ,l,m).

Alt2.5: (applicable to any Alt1.x) bitmap β_{l,m}(λ) is included in group 0.

Alt2.6: (applicable to any Alt1.x) bitmap β_{l,m}(λ) is included in group 1.

As described above, CSI reporting through PUSCH may include UCI part1 and UCI part2. UCI part1 includes an RI and the number (K_{NZ}) of amplitude coefficients of non-zero wideband (WB), and UCI part2 includes PMI of wideband (WB)/subband (SB). The parameter (component) included in UCI part1 may be a parameter (component) of part1 CSI, and the parameter (component) included in UCI part2 may be a parameter (component) of part2 CSI. Here, a payload of UCI part1 is fixed, while a payload of UCI part2 is variable in amount (size) according to RI and K_{NZ}. Therefore, in order to determine the payload of UCI part2, the BS should preferentially decode UCI part1 to calculate RI and K_{NZ} information. Therefore, UCI omission may need to be performed in UCI part2. Hereinafter, UCI omission may be replaced by/mixed with CSI omission so as to be used.

If a precoding matrix indicator (PMI) payload for Type II CSI feedback varies significantly according to RI, a problem that corresponding information cannot all be included in a limited reporting container size at the time of CSI reporting utilizing a PUSCH resource may arise. In addition, since the RI is set by the UE, the BS side may have a limitation in scheduling for resource allocation by accurately predicting a PMI payload for CSI reporting.

For this problem, in the related art, a method of dropping a plurality of reporting settings for a plurality of component carriers (CCs) of part2 CSI according to a predetermined priority rule (CSI) is used in a CSI omission procedure. Based on the received PMI, the BS may calculate the corresponding information by estimating an omitted remaining subband (SB) PMI in an interpolation method. In order to actually determine a payload of UCI part2 transmitted by the UE, the BS performs the same CSI omission process as the UE until the UCI code rate reaches a certain level. Therefore, a common method of omitting CSI must be set/defined between the UE and the BS so that the BS may properly decode the information of UCI part2.

As can be seen in the contents related to the Type II CSI codebook-based CSI reporting, the enhanced Type II CSI codebook may be designed in consideration of frequency domain (FD) compression for a plurality of subbands (SB) CSI by utilizing a basis such as DFT. That is, wireless channel information may be approximated to information (W) on linear combination of the SD basis (W1) and the FD basis (Wf), which are predetermined or set by the UE and the BS in advance so as to be expressed, and the UE may perform CSI reporting by transmitting configuration information \tilde{W}₂ and for the codebook. In this case, complex-valued LC coefficients equal to 2L×M (e.g., the number (2L) of SD components (or basis)×the number of FD components (or basis) are different from the existing SB-specific PMI. That is, since the BS does not know a distribution based on the SD basis, the FD basis, and the layer of the corresponding LC coefficients before decoding the UCI part2 information, the problem cannot be solved through reuse of the related art CSI omission rule/method.

However, if the BS and the UE agree with each other on an omission scheme of LC coefficients and a corresponding bitmap based on the enhanced Type II codebook design, the BS may be able to estimate a CSI omission level performed by the UE by sequentially applying omission until the UCI code rate reaches a specific threshold value code rate. Accordingly, this disclosure proposes a CSI omission (in UCI part2) scheme in an enhanced Type II CSI codebook.

In this disclosure, it is assumed that the Type II CSI codebook (including the enhanced Type II CSI codebook) includes an SD basis-related matrix, an FD basis-related matrix, and a matrix of LC coefficients. Further, the matrix of LC coefficients may include amplitude coefficients and phase coefficients. The codebook may be replaced with terms such as a precoder or a precoding matrix, and the basis may be replaced with terms such as a basis vector, vector, component, and the like. In addition, for convenience of description, the spatial domain may be referred to as SD and the frequency domain as FD.

For example, the codebook may be represented by W=W₁\tilde{W}₂W_{f}^{H}, where W₁ is an SD basis related matrix, \tilde{W}₂ is a matrix of LC coefficients, and W_{f}^{H} is an FD basis related matrix. \tilde{W}₂ may be represented by a matrix having a size of 2L×M. Here, 2L denotes the number of SD bases (where L is the number of beam/antenna ports in SD, and a total number of SD bases may be 2L in consideration of polarization), and M denotes the number of FD bases. Hereinafter, for convenience of description, description will be made based on the Type II CSI codebook.

<Proposal 1: Implicit CSI Omission Scheme>

If the UE is set to have Type II CSI as PUSCH-based reporting and a CSI payload is larger than an allocated resource capacity, an element omitted in a predefined method and an omission scheme may be set/defined for UCI part 2 (i.e., part 2 CSI) information configuration.

In the above method, when the UE wants to report the CSI to the BS, if a corresponding PUSCH resource capacity does not satisfy the CSI payload, some or all of the UCI part 2 components of the CSI are dropped so that the UE may transmit channel information to the BS within an available resource capacity range. Also, the UE may indicate to the BS whether the UCI is configured by performing CSI omission.

As described above, UCI part 2 may include information on bitmap per layer, SD/FD basis indicator, LC coefficients (amplitude/phase) per layer, the shortest coefficient indicator (SCI) per layer. For example, the information on LC coefficients may include an indicator indicating amplitude coefficients and an indicator indicating phase coefficients. Also, the bitmap information per layer may be bitmap information for indicating an indicator indicating the reported amplitude coefficients and an indicator indicating the phase coefficients. Here, the information on the LC coefficients (amplitude coefficient/phase coefficient) and corresponding bitmap information may make biggest influence on the size of the payload among the components. Therefore, it is necessary to specify an omission scheme of these parameters (components) (e.g., amplitude coefficient, phase coefficient, bitmap, etc.), and the omission scheme may be configured by using SCI per layer.

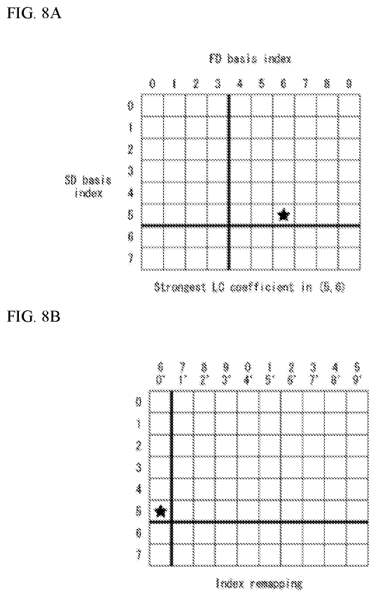

Since the information on the SCI is included in the UCI part 2, the BS cannot know the value before decoding the UCI part 2 based on the UCI part 1 information. However, as described above in the ‘UCI parameter related contents’, as index remapping in accordance with FD basis and LC coefficient in the frequency domain for each layer is performed in a situation where RI>1 to which CSI omission may be applied, the SCI certainly exists in a first column (i.e., column index=0) of \tilde{W}₂ (matrix of LC coefficients), and only a row index may be expressed in a ┌log₂ 2L┐ method, which may be expressed as shown in FIG. 8A and FIG. 8B, for example.

FIG. 8A and FIG. 8B are examples of index remapping of \tilde{W}₂ based on SCI. FIG. 8A shows an index of the SCI at \tilde{W}₂, and FIG. 8B shows an SCI index after index remapping. FIG. 8A and FIG. 8B are only an example for convenience of description and does not limit the technical scope of the present invention. Referring to FIG. 8A and FIG. 8B, the matrix \tilde{W}₂ including LC coefficients has a size of {2L×M}. For example, in the Type II codebook parameter set with L=4 and M=10, the LC matrix \tilde{W}₂ may be configured as a matrix of 8×10 size. As shown in FIG. 8A, assuming that the strongest coefficient is at a position of (5,6), the corresponding index is remapped as shown in FIG. 8B and set to a value corresponding to SCI=5 (i.e., index in the row of SCI after remapping) and reported.

Accordingly, since the corresponding LC coefficients from the FD basis and SD basis corresponding to the SCI may have a greater effect on CSI accuracy compared to other LC coefficients, omission priority may be configured by differentiating the degree of dropping of a specific component in UCI omission.

What's important here is that even if the SCI value included in UCI part 2 is not known, the BS may properly decode the UCI part 2 by adjusting by an omission-applied code rate in a state where the BS and the UE agrees with each other on a method of selecting bitmap/LC coefficients based on the SC. Therefore, it is possible that the listed bitmap and LC coefficients indicate a correct value for \tilde{W}₂ through the decoded SCI.

Hereinafter, a method of performing UCI omission based on SCI per layer in relation to the UCI omission scheme of the enhanced Type II CSI codebook proposed in this disclosure will be described in detail.

Proposal 1-1: For the UCI part 2 information configuration of Type II CSI, a method of setting omitted elements (e.g., bitmap, LC coefficients, etc.) in the frequency domain and an omission scheme is proposed.

1) Method 1

A case where the number of components (or bases) of the frequency domain FD is assumed to be M and M′ number of the components may be selected and reported and the remaining is omitted may be considered. For example, in terms of frequency domain (FD), based on the FD basis(index=0) corresponding to SCI, index=M′−1 (M′<M) number of consecutive LC coefficients or LC coefficients that belong to the columns of \tilde{W}₂ set by a specific rule may be utilized for reporting, and a bitmap size corresponding to the number may be set. That is, the bitmap size may be determined based on the number of reported LC coefficients. In particular, when selecting the columns of \tilde{W}₂ in consideration of a shape of a delay profile, M′/2 may be selected, starting from index=0, and the remaining M′/2 may be selected in reverse order, starting from index=M−1.

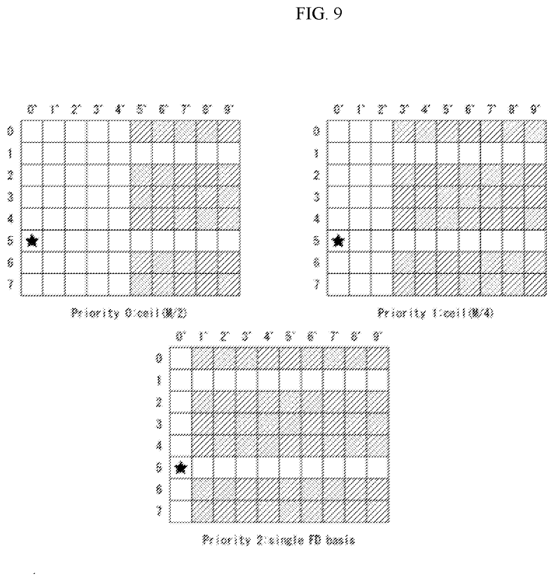

FIG. 9 shows an example of configuring three levels of omission priority in terms of FD along with pair SD bases. In FIG. 9, a situation in which an SD beam index is set to “SD index=5/pair SD index=1” is illustrated as an example. As described later, a priority level for the SD index may also beset. FIG. 9 shows only an example for convenience of description and does not limit the technical scope of the present invention.

FIG. 9 shows an example of a scheme of using LC coefficients that belong to the columns of M′ consecutive columns of \tilde{W}₂ from the FD index=0 described above and dropping other LC coefficients in the situation of the same parameter setting as that of FIG. 8A and FIG. 8B. Here, the degree of dropping refers to preferentially setting to report LC coefficients as many as possible by expressing priority levels for satisfying resource capacity as 0, 1, and 2, while utilizing a specific formula as an example. That is, UCI is configured from a priority level of 0 so that as many LC coefficients as possible may be reported in order to perform CSI reporting within allocated resource capacity, but if resource capacity is insufficient, UCI may be configured by omitting low priority LC coefficients so as to be reported.

2) Method 1-1

As described in the Type II CSI codebook-based CSI reporting related contents, CSI omission related contents, and the like described above, LC combination coefficients (LCC) to be transmitted and LC coefficients to be dropped in a situation where UCI omission is performed may be divided into two groups (G1 and G2) and UCI omission may be performed on one of the two groups. For example, one group may be dropped/omitted according to a priority of the group. Here, a priority level for determining which group a specific LC coefficient belongs to may be expressed as Equation 3. The priority level may also be expressed as a priority value.

Prio(λ,l,m)=2L·RI·Perm₁(m)+RI·Perm₂(l)+λ [Equation 3]

Here, λ denotes a layer index, l denotes an SD basis index, and m denotes an FD basis index. Equation 3 may be based on an assumption that priority of the LC coefficients is given in order of i) layer, ii) SD index, and iii) FD index. In addition, Perm₁( ) and Perm₂( ) indicate permutation schemes for FD index and SD index, respectively. As the Prio( ) (i.e., priority level) in Equation 3 is lower, the corresponding LC coefficient is higher priority.

Specifically, based on the priority given for each LC coefficient, ┌K_{NZ}^{TOT}/2┐ LC coefficients having a higher priority are included in a group (e.g., G1) having a higher priority, and the other remaining ┌K_{NZ}^{TOT}/2┐ LC coefficients are included in a group (e.g., G2) having a lower priority. Here, K_{NZ}^{TOT} refers to a total number of non-zero LC coefficients of \tilde{W}₂. When omission on the CSI is performed, the group having a lower priority may be first omitted. For example, G2 including the LC coefficients having a lower priority may be first omitted as compared with G1. In other words, the LC coefficients having a higher priority are reported and omission may be made, starting from the LC coefficients having a lower priority.

Equation 3 and related descriptions may also be referred to/used in an omission operation of the spatial domain to be described later.

As described above, in the frequency domain (FD) of proposal 1-1, a column corresponding to SCI is located in the 0th column through a modulo (modulus) operation. How SCI information may be reflected in the priority level (or priority value) formula may be handled. That is, a method of performing CSI omission based on SCI per layer may be considered. Permutation for the FD index may be performed based on the following 1)/2)/3) methods, and UCI omission may be performed by calculating a priority level in the frequency domain (FD).

1) A permutation scheme may be configured in ascending order based on the 0th column (i.e., based on the column to which SCI corresponds). That is, Perm1(m)=m may be applied to Equation 3 above. For example, the method of permutation in ascending order may be represented as [0, 1, 2, 3, 4, 5, 6, 7] when M=8. A priority level (i.e., Prio( )) when m=0 may be the lowest, and a priority level when m=7 may be the highest. In other words, the priority when m=0 is the highest, and the priority when m=7 is the lowest. LC coefficients corresponding to m=0 to 3 may be included in a high priority group (e.g., first group (G1)), and LC coefficients corresponding to m=4 to 7 may be included in a low priority group (e.g., second group (G2)).

2) A permutation scheme may be configured in consideration of a delay profile for a channel in terms of FD.

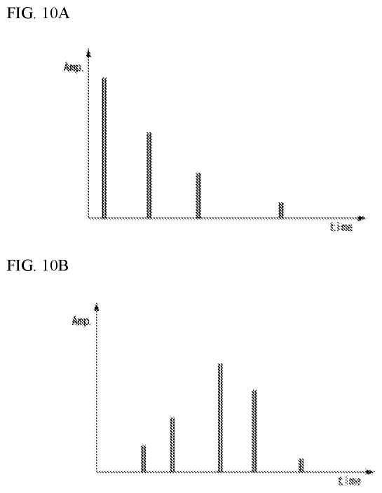

FIG. 10A and FIG. 10B show examples of a delay profile of a wireless channel. FIG. 10A and FIG. 10B show only an example for convenience of description and does not limit the technical scope of the present invention. Referring to FIG. 10A and FIG. 10B, the delay profile of a wireless channel may be represented by two cases. Specifically, i) a situation in which a subset is to be configured by bases of a side where the index increases based on the FD basis corresponding to FD index=0 (FIG. 10A) or ii) a situation in which a basis subset is to be configured in consideration of both sides where the index increases and where the index decreases based on the FD basis corresponding to FD index=0 (FIG. 10B) may typically occur.

Therefore, It is needed a configuration scheme evenly reflecting the bases of the left side and the right side (e.g., the side where the indices increase and the side where the indices decrease), starting from the 0th FD column of \tilde{W}₂ including all M FD bases. That is, the basis index may be selected alternately based on the index 0. For example, based on 0, +1, −1, +2, −2, . . . may be alternately selected. Alternatively, based on 0, −1, +1, −2, +2, . . . may be alternately selected. Alternatively, the basis index may be selected alternately (in a crossing manner) by a circular shift.

As a specific example, the FD index [0, 1, 2, 3, 4, 5, 6, 7] in the case of M=8 may be selected alternately based on FD index=0 according to the above method. For example, the index may be remapped, that is, permutated, such as [0,7,1,6,2,5,3,4], to determine a priority value. LC coefficients whose FD index corresponds [0,7,1,6] are included in the higher priority group (e.g., G1), and LC coefficients whose FD index corresponds to [2,5,3,4] may be included in the lower priority group (e.g., G2).

Or, as an example, the index may be remapped as [0,1,7,2,6,3,5,4]. If this is expressed in a matrix form (Ax=b), it may be expressed as a matrix of Equation 4 below. Here, A represents Perm1( ), x represents an FD index, and b represents an FD index to which permutation is applied.

$$[ \begin{matrix}1 & 0 & 0 & 0 & 0 & 0 & 0 & 0 \\ 0 & 1 & 0 & 0 & 0 & 0 & 0 & 0 \\ 0 & 0 & 0 & 0 & 0 & 0 & 0 & 1 \\ 0 & 0 & 1 & 0 & 0 & 0 & 0 & 0 \\ 0 & 0 & 0 & 0 & 0 & 0 & 1 & 0 \\ 0 & 0 & 0 & 1 & 0 & 0 & 0 & 0 \\ 0 & 0 & 0 & 0 & 0 & 1 & 0 & 0 \\ 0 & 0 & 0 & 0 & 1 & 0 & 0 & 0\end{matrix} ] [ \begin{matrix}0 \\ 1 \\ 2 \\ 3 \\ 4 \\ 5 \\ 6 \\ 7\end{matrix} ] = [ \begin{matrix}0 \\ 1 \\ 7 \\ 2 \\ 6 \\ 3 \\ 5 \\ 4\end{matrix} ] \qquad [ Equation 4 ]$$

That is, based on the permutation (i.e., the remapped index), the priority level when m=0 (i.e., Prio( )) is the lowest and the priority level when m=4 is the highest. In other words, the priority when m=0 is the highest and the priority when m=4 is the lowest.

The omission scheme considering the delay profile described above may be excellent in terms of performance, but it may be necessary for a 1-bit indication of the delay profile shape to be included in UCI part 2 group 0. In other words, it is necessary to indicate/set which delay profile the UE follows (e.g., one of FIG. 10A or FIG. 10B) using 1-bit indication.

3) As a method of guaranteeing CSI performance to some extent, while avoiding such an increase in signaling payload, the ascending permutation scheme may be configured including a −1st or −2nd FD basis. For example, [0, 7, 1, 2, 3, 4, 5, 6] in this order may be represented according to an ascending permutation scheme including a −1st FD basis. For example, [0, 7, 6, 1, 2, 3, 4, 5] in this order may be represented in an ascending permutation scheme including the −2nd FD basis. That is, at least one of the −1st or −2nd FD basis may be located between permutation schemes sorted in ascending order.

As another example, in the permutation configuration, permutation may be configured, starting from −1^{st} or −2^{nd} FD basis, rather than starting from 0^{th} FD basis. The permutation configuration may be expressed as Perm1(m)=(m−A)mod M. Here, A, for example, may be a value set or fixed through an higher layer using a value such as A={M−3, M−2, M−1, 0}, etc. and the UE may include the corresponding information in the UCI part 2 to report the same. As an example of this, when M=8 and A=M−2, it may be permutated as [6 7 0 1 2 3 4 5].

Whether to omit UCI based on which of the permutation schemes among 1)/2)/3) described above in the FD region may be performed according to a scheme predefined between the BS and the UE. Alternatively, the BS may set a permutation scheme to the UE. Alternatively, the UE may report the permutation scheme applied to UCI omission to the BS together with CSI reporting.

Based on the permutation scheme described above, a priority level for the LC coefficients may be calculated, and the LC coefficients may be divided into a plurality of groups based on the priority of the LC coefficients. Depending on the priority of the groups, LC coefficients of a lower group may be omitted. That is, omission may be performed according to the priority of the LC coefficients and reported to the BS.

Proposal 1-2: For the UCI part2 information configuration of Type II CSI, a method of setting omitted elements (e.g., bitmaps, LC coefficients, etc.) and an omission scheme in the spatial domain is proposed.

1) Method 1

Similar to the above proposal 1-1, in the spatial domain (SD) aspect, the LC coefficients that belong to two rows may be configured in a manner of reporting or the like by utilizing the SD basis paired with the SD basis corresponding to the SCI in the antenna port aspect, and a bitmap size may be configured as many as the number of the LC coefficients. Alternatively, LC coefficients that belong to a row of \tilde{W}₂ operated by utilizing ±M′ SD bases based on a specific SD basis or set through a specific rule may be utilized for reporting.

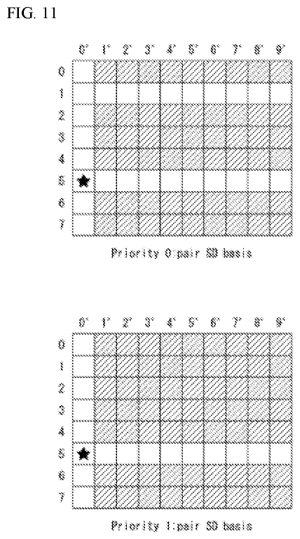

FIG. 11 shows an example of setting priority of omission in terms of SD with a single FD basis. FIG. 11 shows only an example for convenience of description and does not limit the technical scope of the present invention. In FIG. 11, it is assumed that SCI index=5.

Referring to FIG. 11, LC coefficients included in a beam index (index=1) set in antenna ports paired based on SCI (index=5) may be reported and other values may be dropped/omitted. Also, as the number of rows to be reported (to be used) decreases, it is possible to set a difference in the priority level. For example, a priority level may be set by setting a case of reporting a pair SD basis as priority 0 and a case of reporting a single SD basis as priority 1. If it is impossible to report SD bases corresponding to priority 0 within the allocated resource capacity (i.e., if it is impossible to report pair SD bases), SD bases corresponding to priority 1 (i.e., single SD bases) may be reported.

2) Method 1-1

Similar to the methods of proposal 1-1 described above, it is possible to consider a method of performing permutation in consideration of SCI in the permutation scheme in terms of SD. In the spatial domain (SD) of the proposal 1-2, it may be said that the influence of the SD beam corresponding to the value indicated by the SCI is most prominently reflected. Therefore, the permutation scheme such as 1)/2)/3) below may be considered.

1) A scheme of applying permutation in the spatial domain (SD) regardless of SCI, that is, a permutation scheme may be configured in ascending order based on the 0th row. That is, Perm₂(l)=l may be applied to Equation 3 above.

2) A permutation scheme may be configured such that an index is mapped to a row to which the SCI belongs to the 0th row through modulo operation by reflecting SCI information. That is, Perm2(l)=(l−SCI) may be applied as mod 2L. Here, l denotes the SD basis index, and L denotes the number of SD basis vectors. For example, in FIG. 19, when L=4 and SCI=5, a 6th row (SD index=5) is remapped to the 0th index due to the Perm2(l) operation and is equally applied to other SD indices to reset the indices by a circular shift. For example, the row index may be reset as [5, 6, 7, 0, 1, 2, 3, 4]. Therefore, when the remapped row index is 4, it may be first omitted because priority thereof is low.

3) A permutation scheme in which an SD index is preferentially assigned to the SCI and a specific value (SCI_pair) corresponding thereto may be configured. Here, SCI_pair indicates an index having opposite polarization for the SD beam corresponding to the SCI. For example, in the case of L=4, SCI index=5 indicates a second SD beam with [+45 slant angle], and the corresponding SCI_pair is an index having opposite polarization which is the second SD beam with [−45 slant angle], i.e., SD index ‘1’. Therefore, SCI_pair=(SCI-L)mod 2L may be determined for the specific SCI.

Since SCI_pair shares the same SD beam as SCI, it is highly likely to include a large number of LC coefficients affecting CSI accuracy. Therefore, if a priority level is given by mapping the row corresponding to SCI and the row corresponding to SCI_pair to the 0th and 1st indices, it may be effective to reduce loss of CSI accuracy, while performing UCI omission. An SD permutation embodiment for this may be expressed as Perm₂(l)=Aₗ by utilizing FIG. 11 and the related description. Here,

$$A = [ \begin{matrix}SCI ( \text{=} 5 ) \\ SCI\_pair ( \text{=} 1 ) \\ x\end{matrix} ] ,$$

x∈R^{2L-2} is ascending sequence vector (excluding SCI and SCI_pair).

That is, in the above embodiment, x may be expressed as

$$x = [ \begin{matrix}0 \\ 2 \\ 3 \\ 4 \\ 6 \\ 7\end{matrix} ] .$$

Whether to perform UCI omission based on which permutation scheme of 1)/2)/3) described above in the SD area may be performed according to a predefined method between the BS and the UE. Alternatively, the BS may set a permutation scheme to the UE. Alternatively, the UE may report a permutation scheme applied to UCI omission to the BS together with CSI reporting.

The omission in the FD aspect of the proposal 1-1 and the omission in the SD aspect of the proposal 1-2 may each operate independently or may operate in the alternating form, and a corresponding setting may be set through a higher layer or may be predefined.

For example, in Equation 3, the permutation scheme in FD may be performed by one of the methods described in proposal 1-1, and the permutation scheme in SD may be performed by one of the methods described in proposal 1-2, and a priority level may be calculated in consideration of both the permutation in FD and the permutation in SD. As a specific example, in the permutation scheme in FD, a method of alternately selecting a basis index based on index 0 (example: alternately selecting like +1, −1, +2, −2, . . . , based on 0) is applied, and in the permutation scheme in SD, a method of selecting an index in ascending order based on the 0^{th} row may be applied. The UE may perform CSI omission in consideration of the calculated priority level, configure UCI satisfying a size of resource allocated for CSI reporting, and transmit the configured UCI to the BS.

<Proposal 2: Explicit CSI Omission Method>

If the UE is set with Type II CSI as PUSCH-based reporting and a CSI payload is larger than an allocated resource capacity, a UCI omission operation of the UE may be performed, and the UE may consider a method of setting a component of UCI part 2 information and an omission scheme through information (e.g., indicator) related to UCI omission.

Compared with the scheme 1 of proposal 1 in which the degree of CSI omission is implicitly estimated by equally applying the set/defined omission scheme until the UCI code rate satisfies a specific threshold through the RI of the UCI part 1 and the number (NNZC) of non-zero coefficients across layers on the BS side, in the proposal 2, a method in which the UE includes an indicator (example: information related to UCI omission) for omission in the UCI part 1 by including the operation of proposal 1 and transmitting the same to the BS may be considered.

Specifically, the presence or absence of UCI omission, which element of the UCI part 2 was an omission target if UCI omission was performed, how much extent of omission was, and the like, may be set through a higher layer or may be set/transmitted to the BS by a predefined rule. Compared with proposal 1, in proposal 2, a payload of the UCI part 1 may increase, but it is advantageous in that a detailed operation for CSI omission may be agreed between the UE and the BS and the CSI omission may be accurately recognized.

For example, LC coefficients are configured for each of amplitude and phase, of which one may be indicated to be dropped/omitted. Alternatively, it is possible to specify an omission setting scheme in terms of the FD and/or SD and designation of a layer-common/layer-group-specific operation of the corresponding operation may be agreed and applied. Alternatively, configuring UCI part 2 by adjusting a quantization degree of the amplitude and phase of the LC coefficients may obtain a significant effect in terms of payload reduction.

As an example of a method of setting a component of UCI part 2 and an omission scheme according to information (example: UCI omission indicator) related to UCI omission, Table 14 shows an example of Type II CSI omission operation according to a UCI omission indicator in case of layer-common.

TABLE 14

| Indicator | LC coefficients | | Omission priority | | Quantization degree | |
|---|---|---|---|---|---|---|
| (2bits) | Amp. | Phase | FD | SD | Amp. | Phase |
| ′00′ | Default | Default | Default | Default | Default | Default |
| ′01′ | O | X | 2 | 1 | QPSK | — |
| ′10′ | X | O | 1 | 1 | — | 8-PSK |
| ′11′ | O | O | 0 | 0 | 16-PSK | 16-PSK |

The UE may transmit/set information such as whether to omit LC coefficients (e.g., amplitude coefficient and phase coefficient), omission priority for frequency domain and spatial domain, and quantization degree through information (e.g., indicator) related to UCI omission to the BS. The BS may clearly recognize the UCI omission operation of the UE based on the information related to the UCI omission.

Through the proposed method and/or embodiments described above, the UE may perform UCI omission within an allocated resource capacity and report channel state information to the BS.

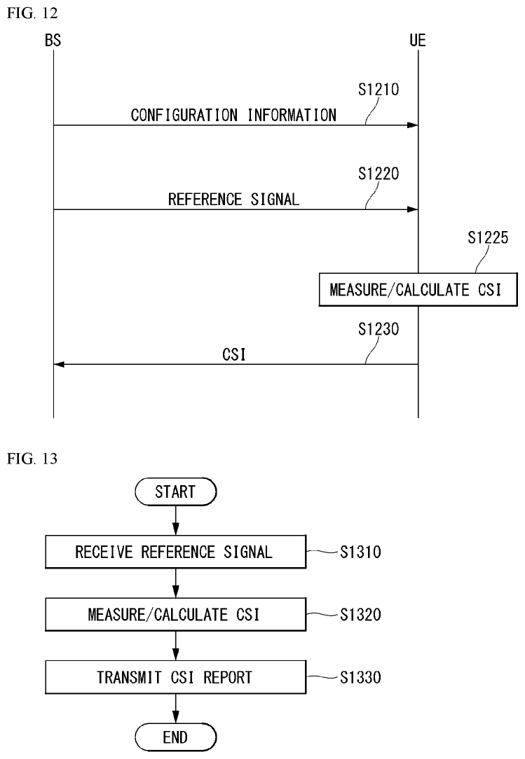

FIG. 12 shows an example of a signaling flowchart between a UE and a BS to which the method and/or embodiment proposed in this disclosure may be applied. FIG. 12 is only for convenience of description and does not limit the scope of the present invention. Referring to FIG. 12, it is assumed that the UE and/or the BS operate based on the methods and/or embodiments of the proposals 1 and 2 described above. Some of the steps described in FIG. 12 may be merged or omitted. In addition, in performing the procedures described below, the CSI-related operation of FIG. 7 may be considered/applied.

The BS may collectively refer to an object that transmits and receives data to and from a UE. For example, the BS may be a concept including one or more transmission points (TPs), one or more transmission and reception points (TRPs), and the like. Further, the TP and/or TRP may include a panel, a transmission and reception unit, and the like of the BS. In addition, TRP may be classified according to information (e.g., index, ID) on a CORESET group (or CORESET pool). For example, if one UE is configured to perform transmission and reception with multiple TRPs (or cells), this may mean that multiple CORESET groups (or CORESET pools) are set for one UE. The setting of the CORESET groups (or CORESET pools) may be performed through higher layer signaling (e.g., RRC signaling, etc.).

The UE may receive configuration information from the BS (S1210). That is, the BS may transmit the configuration information to the UE. The configuration information may be received through higher layer signaling (e.g., radio resource control (RRC) or medium access control-control element (MAC-CE)). For example, the configuration information may be configuration information related to CSI. For example, when the configuration information is set in advance, a corresponding step may be omitted.

The configuration information may include configuration information for a reference signal for CSI. For example, the configuration information for the reference signal may include information on a period in which the reference signal is transmitted, time domain behavior information of the reference signal, and the like. In addition, the configuration information for the reference signal may include information on a resource and/or resource set in which the reference signal is transmitted.

The configuration information may include information on a CSI reporting setting. For example, whether it is a PUSCH-based CSI reporting or a PUCCH-based CSI reporting may be set based on the configuration information. In addition, the configuration information may include resource allocation information for CSI reporting.

For example, the configuration information may include information related to a CSI omission operation of the UE. For example, it may include information (e.g., permutation scheme) used when determining priority of the CSI.

The UE may receive a reference signal (RS) from the BS (S1220). That is, the BS may transmit the reference signal to the UE. For example, the reference signal may be received or transmitted based on the configuration information. For example, the reference signal may be CSI-RS. The reference signal may be transmitted periodically, semi-permanently or aperiodically from the BS. In addition, the reference signal may be used for CSI measurement and calculation.

The UE may measure/calculate CSI (S1225). For example, the CSI may be measured/calculated based on an (enhanced) Type II CSI codebook and may include information on a precoding matrix (e.g., PMI, etc.). For example, a precoding matrix based on a linear combination of a basis in the frequency domain and a basis in the spatial domain may be used for CSI calculation. A row index of the precoding matrix may be related to the basis of the spatial domain, and a column index of the matrix may be related to the basis of the frequency domain. The column index of the strongest coefficient indicator (SCI) may correspond to ‘0’.

The CSI may include information related to linear combination coefficients (e.g., amplitude coefficient, phase coefficient, etc.), for example, information on the amplitude coefficient, information on the phase coefficient, information in a bitmap form related to the coefficients (amplitude coefficient and phase coefficient), information on the strongest coefficient for each layer, information on the basis of the spatial domain, information on the basis of the frequency domain, and the like.

The UE may transmit CSI to the BS (S1230). That is, the BS may receive the CSI from the UE. For example, the CSI may be transmitted via a PUSCH or PUCCH. The CSI reporting transmitted to the BS may include a first part and a second part. For example, the first part may correspond to the UCI part 1 (i.e., part 1 CSI) and the second part may correspond to the UCI part 2 (i.e., part 2 CSI) described above.

A resource for CSI reporting may be allocated based on the configuration information, and if an allocated resource capacity is smaller than a UCI payload (i.e., CSI payload to be reported) size, CSI reporting may be configured by omitting some of the calculated CSI so that CSI reporting may be performed within an available resource capacity range. For example, some of the components configuring the second part (i.e., UCI part 2) of the CSI reporting may be omitted. The operation related to the CSI omission may be performed based on the proposed method (e.g., proposal 1/proposal 2) described above.

For example, information on the amplitude coefficient, information on the phase coefficient, and bitmap information related to the coefficients may each be classified into a plurality of groups based on a priority value. The priority value and priority of the components of each information may be inversely proportional. That is, as the priority value is smaller, the priority of the corresponding component may be higher. For example, among the components of the information on the amplitude coefficient, the information on the phase coefficient, and the bitmap information related to the coefficients, a component having a higher priority may be included in a first group and a component having a lower priority may be included in a second group.

In addition, when performing omission on the CSI, a group having a lower priority may be omitted first. For example, the first group may have a higher priority than the second group. Therefore, the second group may be omitted earlier than the first group. In other words, the information on the amplitude coefficient having a higher priority, the information on the phase coefficient, and the bitmap information may be reported and information having a lower priority, starting from information having the lowest priority, may be omitted.

The priority value used to classify the components of the information on the amplitude coefficient, the information on the phase coefficient, and/or the bitmap information related to the coefficients into a plurality of groups may be determined based on at least one of i) a layer index, ii) an index of the spatial domain associated with each component, or iii) an index of the frequency domain associated with each component. In one example, the priority value may be determined based on i) layer index, ii) index of the spatial domain associated with each component, and iii) frequency domain index associated with each component.

For example, the priority value may increase in order in which a higher index and a lower index of the indices of the frequency domain associated with the components sequentially alternated each other based on a predefined specific index. The predefined specific index may be associated with an index of the frequency domain of the strongest coefficient among the coefficients. As an example, the predefined specific index may be ‘0’. This is because the index is remapped so that the index of the strongest coefficient in the frequency domain is located at a first column (i.e., column index=0).

As another example, the priority value may increase in ascending order of the index of the spatial domain. As another example, a priority of i) an index of the spatial domain of the strongest coefficient and ii) an index of the spatial domain corresponding to a beam having opposite polarization with respect to a beam corresponding to the strongest coefficient may be highest (that is, the priority value may be the smallest). Thereafter, the priority values of the remaining indices may be sequentially determined in ascending order. Alternatively, the index may be remapped so that the index of the spatial domain of the strongest coefficient becomes 0, the other remaining indices may be remapped in a cyclic shift form, and the priority values may then be determined in order of the remapped indices.

As another example, if some of the bases (or components) (e.g., M) of the frequency domain are reported (e.g., M′) and the others are omitted, consecutive indices may be selected by the umber of the bases to be reported based on an index (e.g., index=0) of the strongest coefficient in the frequency domain and information on the corresponding coefficients and information in a bitmap form corresponding to the coefficients may be reported. As a similar example, when reporting some of the bases (or components) of the spatial domain, coefficients corresponding to the index of the strongest coefficient in the spatial domain and the index of the SD basis that is paired in terms of antenna ports and the information in the bitmap form corresponding to the coefficients may be reported (remaining coefficients corresponding to the SD basis index and the information in the bitmap form corresponding thereto may be omitted).

For example, the CSI reporting may further include information indicating a delay profile applied by the UE or information used by the UE to determine priority for CSI omission (e.g., permutation scheme), and the like.

As described in the proposal 2 above, the CSI reporting may further include information related to the CSI omission operation. In other words, the UE may explicitly transmit information related to the CSI omission operation to the BS. For example, since the CSI reporting may be configured by omitting a specific group according to priority of a plurality of groups, the CSI reporting may include information related to omission of the omitted specific group. For example, information related to the CSI omission operation may be included in the first part of the CSI reporting and transmitted.

For example, the information related to the CSI omission operation may include information on at least one of i) the presence or absence of omission operation (i.e., whether the UE has performed omission), ii) an omission subject, or iii) an omission degree (omission quantity). The UE may transmit/set information such as whether to omit coefficients, omission priority for a frequency domain and a spatial domain, and quantization degree to the BS through information (e.g., indicator) related to CSI omission. The BS may clearly recognize the CSI omission operation of the UE based on the information related to the CSI omission.

FIG. 13 shows an example of a flowchart between a UE and a BS to which the method and/or embodiment proposed in this disclosure may be applied. FIG. 13 is only for convenience of description and does not limit the scope of the present invention. Referring to FIG. 13, it is assumed that the UE and/or the BS operate based on the methods and/or embodiments of the proposals 1 and 2 described above. Some of the steps described in FIG. 13 may be merged or omitted. In addition, in performing the procedures described below, the CSI-related operation of FIG. 7 may be considered/applied.

The UE may receive a reference signal (RS) from the BS (S1310). For example, the RS may be received based on the CSI-related configuration information. For example, the RS may be a CSI-RS. The RS may be transmitted periodically, semi-permanently, or aperiodically from the BS. In addition, the RS may be used for CSI measurement and calculation.

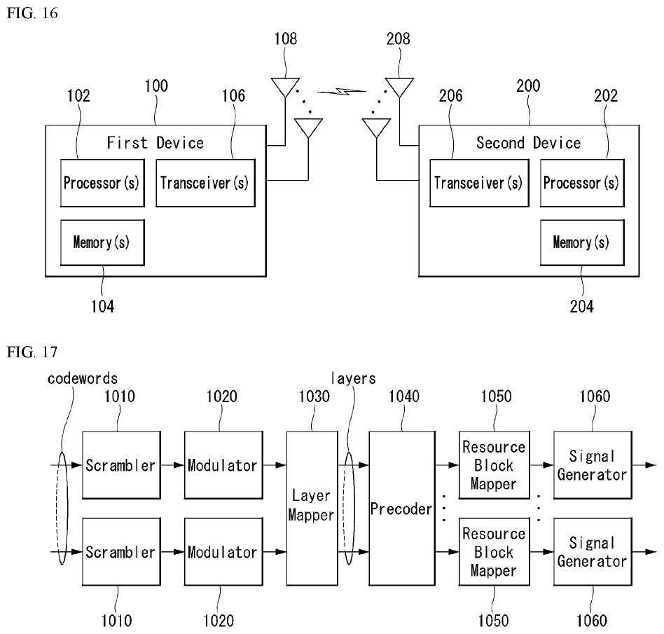

For example, the operation in which the UE (100/200 of FIGS. 15 to 19) receives the RS from the BS (100/200 of FIGS. 15 to 19) in step S1310 described above may be implemented by the device of FIGS. 15 to 19. For example, referring to FIG. 16, at least one processor 202 may control at least one transceiver 206 and/or at least one memory 204 to receive the RS, and the at least one transceiver 206 may receive the RS from the BS.

The UE may measure/calculate the CSI (S1320). For example, the CSI may be measured/calculated based on an (enhanced) Type II CSI codebook and may include information on a precoding matrix (e.g., PMI, etc.).

For example, the CSI may include information related to coefficients. The information related to the coefficients may include at least one of i) information on an amplitude coefficient, ii) information on a phase coefficient, or iii) bitmap information related to the amplitude coefficient and the phase coefficient.

For example, the operation in which the UE (100/200 of FIGS. 15 to 19) measures/calculates the CSI in step S1320 described above may be implemented by the device of FIGS. 15 to 19 to be described hereinafter. For example, referring to FIG. 16, the at least one processor 202 may control at least one transceiver 206 and/or at least one memory 204 to measure/calculate the CSI.

The UE may transmit CSI reporting to the BS (S1330). The CSI reporting may be transmitted via a physical uplink shared channel (PUSCH) or a physical uplink control channel (PUCCH). The CSI reporting may include a first part and a second part. For example, the first part may correspond to the UCI part 1 (i.e., part 1 CSI) and the second part may correspond to the UCI part 2 (i.e., part 2 CSI) described above.

Apart of the second part of the CSI reporting may be omitted. The omission of the second part of the CSI reporting may be performed based on the proposed methods (e.g., proposal 1, proposal 2, etc.) described above. For example, each of the elements of the information related to the coefficients (e.g., information on the amplitude coefficient, information on the phase coefficient, and bitmap information related to the amplitude coefficient and the phase coefficient) may be classified into a plurality of groups based on priority values, and a specific group may be omitted according to a priority of the plurality of groups to configure CSI reporting. A lower priority group may be omitted first. As an example, a specific group to be included in the second part of the CSI reporting may be omitted.

For example, among components of the information related to the coefficients according to the priority determined based on the priority value, a component having a higher priority may be included in a first group and a component having a lower priority may be included in a second group. Priority of the first group may be higher than priority of the second group, and thus, the second group may be omitted earlier than the first group.

The priority value may be determined based on at least one of i) a layer index ii) an index of a spatial domain associated with each component or iii) an index of a frequency domain associated with each component. In one example, the priority value may be determined based on i) the layer index ii) the index of a spatial domain associated with each component and iii) the index of a frequency domain associated with each component.

For example, the priority value may increase in order in which a higher index and a lower index of the indices of the frequency domain associated with the components sequentially alternate each other based on a predefined specific index. The predefined specific index may be associated with an index of the frequency domain of the strongest coefficient among the coefficients. As an example, the predefined specific index may be ‘0’.

As another example, the priority value may increase in ascending order of the index of the spatial domain. As another example, a priority of i) an index of the spatial domain of the strongest coefficient and ii) an index of the spatial domain corresponding to a beam having opposite polarization with respect to a beam corresponding to the strongest coefficient may be highest (that is, the priority value may be the smallest). Thereafter, the priority values of the remaining indices may be sequentially determined in ascending order. Alternatively, the index may be remapped so that the index of the spatial domain of the strongest coefficient becomes 0, the other remaining indices may be remapped in a cyclic shift form, and the priority values may then be determined in order of the remapped indices.

As another example, if some of the bases (or components) (e.g., M) of the frequency domain are reported (e.g., M′) and the others are omitted, consecutive indices may be selected by the umber of the bases to be reported based on an index (e.g., index=0) of the strongest coefficient in the frequency domain and information on the corresponding coefficients and information in a bitmap form corresponding to the coefficients may be reported. As a similar example, when reporting some of the bases (or components) of the spatial domain, coefficients corresponding to the index of the strongest coefficient in the spatial domain and the index of the SD basis that is paired in terms of antenna ports and the information in the bitmap form corresponding to the coefficients may be reported (remaining coefficients corresponding to the SD basis index and the information in the bitmap form corresponding thereto may be omitted).

The CSI reporting may further include information related to CSI omission. For example, since the CSI reporting may be configured by omitting a specific group according to a priority of a plurality of groups, the CSI reporting may include information related to omission of the omitted specific group. For example, the information related to the omission of the specific group may include at least one of i) whether to omit (i.e., whether the UE has performed omission), ii) an omission subject, or iii) the degree of omission (or omission quantity). For example, the information related to the CSI omission (i.e., information related to omission of a specific group) may be included and transmitted in the first part of the CSI reporting.

For example, the operation in which the UE (100/200 of FIGS. 15 to 19) transmits the CSI reporting to the BS (100/200 of FIGS. 15 to 19) in step S1330 described above may be implemented by the device of FIGS. 15 to 19 to be described hereinafter. For example, referring to FIG. 16, at least one processor 202 may control at least one transceiver 206 and/or at least one memory 204 to transmit CSI reporting, and the at least one transceiver 206 may transmit the CSI reporting to the BS.

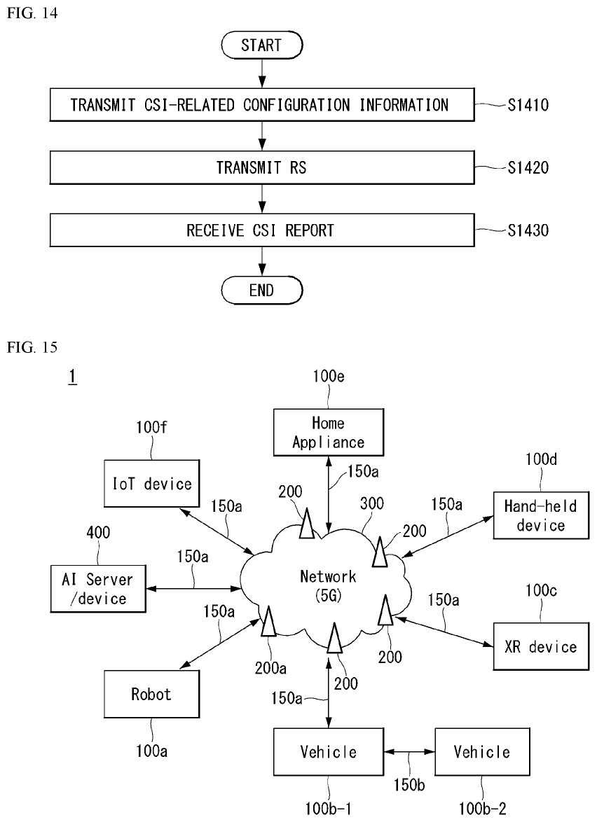

FIG. 14 shows an example of a flowchart between a UE and a BS to which the method and/or embodiment proposed in this disclosure may be applied. FIG. 14 is only for convenience of description and does not limit the scope of the present invention. Referring to FIG. 14, it is assumed that the UE and/or the BS operate based on the methods and/or embodiments of the proposals 1 and 2 described above. Some of the steps described in FIG. 14 may be merged or omitted. In addition, in performing the procedures described below, the CSI-related operation of FIG. 7 may be considered/applied.

The BS may collectively refer to an object that transmits and receives data to and from a UE. For example, the BS may be a concept including one or more transmission points (TPs), one or more transmission and reception points (TRPs), and the like. Further, the TP and/or TRP may include a panel, a transmission and reception unit, and the like of the BS. In addition, TRP may be classified according to information (e.g., index, ID) on a CORESET group (or CORESET pool). For example, if one UE is configured to perform transmission and reception with multiple TRPs (or cells), this may mean that multiple CORESET groups (or CORESET pools) are set for one UE. The setting of the CORESET groups (or CORESET pools) may be performed through higher layer signaling (e.g., RRC signaling, etc.).

The BS may transmit configuration information related to CSI to the UE (S1410). The CSI-related configuration information may be transmitted through higher layer signaling (e.g., RRC or MAC-CE).

The CSI-related configuration information may include configuration information on a RS for CSI and resource allocation information for CSI reporting For example, the configuration information for the reference signal may include information on a period in which the reference signal is transmitted, time domain behavior information of the reference signal, and the like. In addition, the configuration information for the reference signal may include information on a resource and/or resource set in which the reference signal is transmitted. In addition, the CSI-related configuration information may include information on CSI reporting setting. For example, whether it is PUSCH-based CSI reporting or PUCCH-based CSI reporting may be set based on the information on the CSI reporting setting. For example, the CSI-related configuration information may include information related to a CSI omission operation of the UE. For example, it may include information (e.g., permutation scheme) used when determining the priority of the CSI.

For example, the operation in which the BS (100/200 of FIGS. 15 to 19) in step S1410 described above transmits the CSI-related configuration information to the UE (100/200 of FIGS. 15 to 19) may be implemented by the device of FIGS. 15 to 19 to be described hereinafter. For example, referring to FIG. 16, at least one processor 202 may control at least one transceiver 206 and/or at least one memory 204 to transmit the CSI-related configuration information, and the at least one transceiver 206 may transmit the CSI related configuration information to the UE.

The BS may transmit an RS to the UE (S1420). For example, the RS may be transmitted based on the CSI-related configuration information described above. For example, the RS may be a CSI-RS. The RS may be transmitted periodically, semi-permanently, or aperiodically. In addition, the RS may be used for CSI measurement and calculation of the UE.

For example, the operation in which the BS (100/200 of FIGS. 15 to 19) transmits an RS to the UE (100/200 of FIGS. 15 to 19) in step S1420 described above may be implemented by the device of FIG. 19. For example, referring to FIG. 16, at least one processor 202 may control at least one transceiver 206 and/or at least one memory 204 to transmit the RS, and the at least one transceiver 206 may transmit the RS to the UE.

The BS may receive CSI reporting from the UE (S1430). The CSI reporting may be transmitted via a PUSCH or PUCCH. The CSI reporting may include a first part and a second part. For example, the first part may correspond to the UCI part 1 (i.e., part 1 CSI) described above, and the second part may correspond to the UCI part 2 (i.e., part 2 CSI).

For example, the CSI may be measured/calculated based on an (enhanced) Type II CSI codebook and may include information on a precoding matrix (e.g., PMI, etc.). For example, the CSI may include information related to coefficients. The information related to the coefficients may include at least one of i) information on an amplitude coefficient, ii) information on a phase coefficient, or iii) bitmap information related to the amplitude coefficient and the phase coefficient.

A part of the second part of the CSI reporting may be omitted based on the proposed methods (e.g., proposal 1, proposal 2, etc.) described above. For example, each of the elements of the information related to the coefficients (e.g., information on the amplitude coefficient, information on the phase coefficient, and bitmap information related to the amplitude coefficient and the phase coefficient) may be classified into a plurality of groups based on priority values, and a specific group may be omitted according to a priority of the plurality of groups to configure CSI reporting. A lower priority group may be omitted first.

The priority value may be determined based on at least one of i) a layer index ii) an index of a spatial domain associated with each component or iii) an index of a frequency domain associated with each component. In one example, the priority value may be determined based on i) the layer index ii) the index of a spatial domain associated with each component and iii) the index of a frequency domain associated with each component.

For example, the priority value may increase in order in which a higher index and a lower index of the indices of the frequency domain associated with the components sequentially alternate each other based on a predefined specific index. The predefined specific index may be associated with an index of the frequency domain of the strongest coefficient among the coefficients. As an example, the predefined specific index may be ‘0’. As another example, the priority value may increase in ascending order of the index of the spatial domain.

For example, the operation in which the BS (100/200 of FIGS. 15 to 19) receives the CSI reporting from the UE (100/200 of FIGS. 15 to 19) in step S1430 described above may be implemented by the device of FIGS. 15 to 19 to be described hereinafter. For example, referring to FIG. 16, at least one processor 202 may control at least one transceiver 206 and/or at least one memory 204 to receive CSI reporting, and the at least one transceiver 206 may receive CSI reporting from the UE.

In addition, the methods and embodiments (e.g., proposal 1/proposal 2, etc.) described above and the UE and/or BS operating according to each step of FIG. 13 or 14 may be specifically implemented by the device of FIGS. 15 to 19 to be described hereinafter. For example, the BS may correspond to a first wireless device and the UE may correspond to a second wireless device, and vice versa.

For example, the BS/UE signaling and operation (e.g., FIG. 12/FIG. 13/FIG. 14, etc.) described above may be processed by at least one processor (e.g., 102, 202) of FIGS. 15 to 19. In addition, the BS/UE signaling and operation (e.g., FIG. 12/FIG. 13/FIG. 14, etc.) described above may be stored in the form of an instruction/program (example: instruction, executable code) for driving at least one processor (example: 102, 202) of FIGS. 15 to 19 in a memory (example: at least one memory (e.g., 104, 204) of FIGS. 15 to 19).

Communication System Applied to the Present Disclosure

The various descriptions, functions, procedures, proposals, methods, and/or operational flowcharts of the present invention described in this document may be applied to, without being limited to, a variety of fields requiring wireless communication/connection (e.g., 5G) between devices

Hereinafter, a description will be given in more detail with reference to the drawings. In the following drawings/description, the same reference symbols may denote the same or corresponding hardware blocks, software blocks, or functional blocks unless described otherwise.

FIG. 15 illustrates a communication system applied to the present invention.

Referring to FIG. 15, a communication system (1) applied to the present invention includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. Relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least apart of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present invention.

Devices Applicable to the Present Invention

FIG. 16 illustrates wireless devices applicable to the present invention.

Referring to FIG. 16, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 15.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present invention, the wireless device may represent a communication modem/circuit/chip.

The second wireless device 200 may include at least one processor 202 and at least one memory 204 and additionally further include at least one transceiver 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 206 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present invention, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. From RF band signals into baseband signals in order to process received user data, control information, radio signals/channels, etc. Using the one or more processors 102 and 202. The one or more transceivers 106 and 206 may convert the user data, control information, radio signals/channels, etc. Processed using the one or more processors 102 and 202 from the base band signals into the RF band signals. To this end, the one or more transceivers 106 and 206 may include (analog) oscillators and/or filters.

Signal Processing Circuit Example to which Present Invention is Applied

FIG. 17 illustrates a signal processing circuit for a transmit signal.

Referring to FIG. 17, a signal processing circuit 1000 may include a scrambler 1010, a modulator 1020, a layer mapper 1030, a precoder 1040, a resource mapper 1050, and a signal generator 1060. Although not limited thereto, an operation/function of FIG. 17 may be performed by the processors 102 and 202 and/or the transceivers 106 and 206 of FIG. 16. Hardware elements of FIG. 17 may be implemented in the processors 102 and 202 and/or the transceivers 106 and 206 of FIG. 16. For example, blocks 1010 to 1060 may be implemented in the processors 102 and 202 of FIG. 16. Further, blocks 1010 to 1050 may be implemented in the processors 102 and 202 of FIG. 16 and the block 1060 of FIG. 16 and the block 1060 may be implemented in the transceivers 106 and 206 of FIG. 16.

A codeword may be transformed into a radio signal via the signal processing circuit 1000 of FIG. 17. Here, the codeword is an encoded bit sequence of an information block. The information block may include transport blocks (e.g., a UL-SCH transport block and a DL-SCH transport block). The radio signal may be transmitted through various physical channels (e.g., PUSCH and PDSCH).

Specifically, the codeword may be transformed into a bit sequence scrambled by the scrambler 1010. A scramble sequence used for scrambling may be generated based on an initialization value and the initialization value may include ID information of a wireless device. The scrambled bit sequence may be modulated into a modulated symbol sequence by the modulator 1020. A modulation scheme may include pi/2-BPSK(pi/2-Binary Phase Shift Keying), m-PSK(m-Phase Shift Keying), m-QAM(m-Quadrature Amplitude Modulation), etc. A complex modulated symbol sequence may be mapped to one or more transport layers by the layer mapper 1030. Modulated symbols of each transport layer may be mapped to a corresponding antenna port(s) by the precoder 1040 (precoding). Output z of the precoder 1040 may be obtained by multiplying output y of the layer mapper 1030 by precoding matrix W of N*M. Here, N represents the number of antenna ports and M represents the number of transport layers. Here, the precoder 1040 may perform precoding after performing transform precoding (e.g., DFT transform) for complex modulated symbols. Further, the precoder 1040 may perform the precoding without performing the transform precoding.

The resource mapper 1050 may map the modulated symbols of each antenna port to a time-frequency resource. The time-frequency resource may include a plurality of symbols (e.g., CP-OFDMA symbol and DFT-s-OFDMA symbol) in a time domain and include a plurality of subcarriers in a frequency domain. The signal generator 1060 may generate the radio signal from the mapped modulated symbols and the generated radio signal may be transmitted to another device through each antenna. To this end, the signal generator 1060 may include an Inverse Fast Fourier Transform (IFFT) module, a Cyclic Prefix (CP) inserter, a Digital-to-Analog Converter (DAC), a frequency uplink converter, and the like.

A signal processing process for a receive signal in the wireless device may be configured in the reverse of the signal processing process (1010 to 1060) of FIG. 17. For example, the wireless device (e.g., 100 or 200 of FIG. 16) may receive the radio signal from the outside through the antenna port/transceiver. The received radio signal may be transformed into a baseband signal through a signal reconstructer. To this end, the signal reconstructer may include a frequency downlink converter, an analog-to-digital converter (ADC), a CP remover, and a Fast Fourier Transform (FFT) module. Thereafter, the baseband signal may be reconstructed into the codeword through a resource de-mapper process, a postcoding process, a demodulation process, and a de-scrambling process. The codeword may be reconstructed into an original information block via decoding. Accordingly, a signal processing circuit (not illustrated) for the receive signal may include a signal reconstructer, a resource demapper, a postcoder, a demodulator, a descrambler, and a decoder.

Example of a Wireless Device Applied to the Present Disclosure

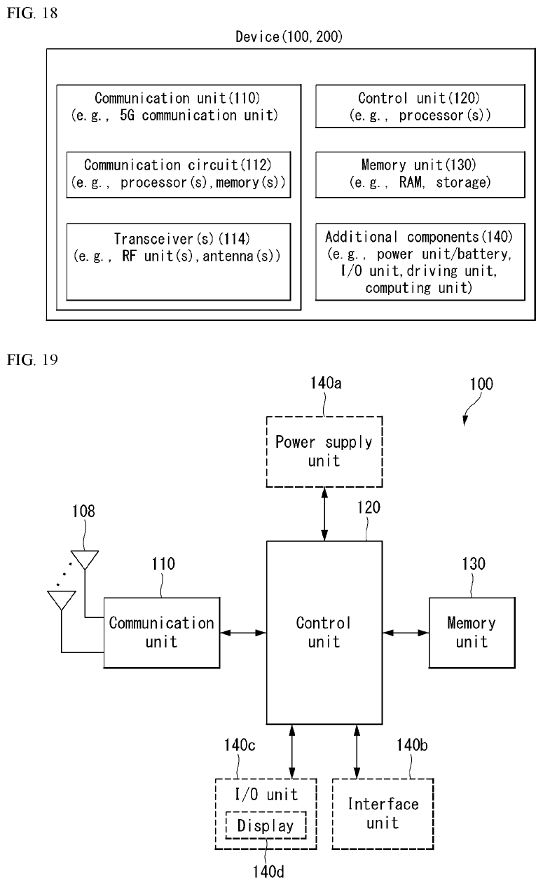

FIG. 18 illustrates another example of a wireless device applied to the present invention. The wireless device may be implemented in various forms according to a use-case/service (refer to FIG. 15).

Referring to FIG. 18, wireless devices 100 and 200 may correspond to the wireless devices 100 and 200 of FIG. 16 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 104 of FIG. 16. For example, the transceiver(s) 114 may include the one or more transceivers 106 and 106 and/or the one or more antennas 108 and 108 of FIG. 16. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110).

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 15), the vehicles (100b-1 and 100b-2 of FIG. 15), the XR device (100c of FIG. 15), the hand-held device (100d of FIG. 15), the home appliance (100e of FIG. 15), the IoT device (100f of FIG. 15), a digital broadcast terminal, a hologram device, a public safety device, an MTC device, a medicine device, a fintech device (or a finance device), a security device, a climate/environment device, the AI server/device (400 of FIG. 15), the BSs (200 of FIG. 15), a network node, etc. The wireless device may be used in a mobile or fixed place according to a use-example/service.

In FIG. 18, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Portable Device Example to which Present Invention is Applied

FIG. 19 illustrates a portable device applied to the present invention. The portable device may include a smart phone, a smart pad, a wearable device (e.g., a smart watch, a smart glass), and a portable computer (e.g., a notebook, etc.). The portable device may be referred to as a Mobile Station (MS), a user terminal (UT), a Mobile Subscriber Station (MSS), a Subscriber Station (SS), an Advanced Mobile Station (AMS), or a Wireless terminal (WT).

Referring to FIG. 19, a portable device 100 may include an antenna unit 108, a communication unit 110, a control unit 120, a memory unit 130, a power supply unit 140a, an interface unit 140b, and an input/output unit 140c. The antenna unit 108 may be configured as a part of the communication unit 110. The blocks 110 to 130/140a to 140c correspond to the blocks 110 to 130/140 of FIG. 18, respectively

The communication unit 110 may transmit/receive a signal (e.g., data, a control signal, etc.) to/from another wireless device and eNBs. The control unit 120 may perform various operations by controlling components of the portable device 100. The control unit 120 may include an Application Processor (AP). The memory unit 130 may store data/parameters/programs/codes/instructions required for driving the portable device 100. Further, the memory unit 130 may store input/output data/information, etc. The power supply unit 140a may supply power to the portable device 100 and include a wired/wireless charging circuit, a battery, and the like. The interface unit 140b may support a connection between the portable device 100 and another external device. The interface unit 140b may include various ports (e.g., an audio input/output port, a video input/output port) for the connection with the external device. The input/output unit 140c may receive or output a video information/signal, an audio information/signal, data, and/or information input from a user. The input/output unit 140c may include a camera, a microphone, a user input unit, a display unit 140d, a speaker, and/or a haptic module.

As one example, in the case of data communication, the input/output unit 140c may acquire information/signal (e.g., touch, text, voice, image, and video) input from the user and the acquired information/signal may be stored in the memory unit 130. The communication unit 110 may transform the information/signal stored in the memory into the radio signal and directly transmit the radio signal to another wireless device or transmit the radio signal to the eNB. Further, the communication unit 110 may receive the radio signal from another wireless device or eNB and then reconstruct the received radio signal into original information/signal. The reconstructed information/signal may be stored in the memory unit 130 and then output in various forms (e.g., text, voice, image, video, haptic) through the input/output unit 140c.

The embodiments described above are implemented by combinations of components and features of the present invention in predetermined forms. Each component or feature should be considered selectively unless specified separately. Each component or feature may be carried out without being combined with another component or feature. Moreover, some components and/or features are combined with each other and may implement embodiments of the present invention. The order of operations described in embodiments of the present invention may be changed. Some components or features of one embodiment may be included in another embodiment, or may be replaced by corresponding components or features of another embodiment. It is apparent that some claims referring to specific claims may be combined with another claims referring to the claims other than the specific claims to constitute the embodiment or add new claims by means of amendment after the application is filed.

Embodiments of the present invention may be implemented by various means, for example, hardware, firmware, software, or combinations thereof. When embodiments are implemented by hardware, one embodiment of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

When embodiments are implemented by firmware or software, one embodiment of the present invention may be implemented by modules, procedures, functions, etc. Performing functions or operations described above. Software code may be stored in a memory and may be driven by a processor. The memory is provided inside or outside the processor and may exchange data with the processor by various well-known means.

It is apparent to those skilled in the art that the present invention may be embodied in other specific forms without departing from essential features of the present invention. Accordingly, the aforementioned detailed description should not be construed as limiting in all aspects and should be considered as illustrative. The scope of the present invention should be determined by rational construing of the appended claims, and all modifications within an equivalent scope of the present invention are included in the scope of the present invention.

The method for reporting channel status information in a wireless communication system of the present invention has been described based on an example applied to a 3GPP LTE/LTE-A system and a 5G system (new RAT system), but the method may be applied to various other wireless communication systems.

According to an embodiment of the present disclosure, channel state information (CSI) may be reported to a base station (BS) in consideration of a payload size of the CSI.

In addition, according to an embodiment of the present disclosure, the CSI may be reported within an allocated resource capacity by omitting a part of the CSI.

In addition, according to an embodiment of the present disclosure, the CSI may be reported by minimizing loss of information within the allocated resource capacity by performing an omission operation in consideration of the priority of the elements of the CSI.

In addition, according to an embodiment of the present disclosure, ambiguity of an operation related to CSI omission may be eliminated.

Effects which may be obtained by the present disclosure are not limited to the aforementioned effects, and other technical effects not described above may be evidently understood by a person having ordinary skill in the art to which the present disclosure pertains from the following description.

What is claimed is:

1. A method of reporting channel state information (CSI) by a user equipment (UE) in a wireless communication system, the method comprising:
receiving a reference signal from a base station (BS);
calculating CSI based on the reference signal, wherein the CSI includes information related to coefficients, elements of the information related to the coefficients are classified into a plurality of groups based on priority values, respectively, and the priority values increase in order in which a higher index and a lower index of indices of a frequency domain associated with the elements are sequentially alternated based on a predefined specific index; and
transmitting, to the BS, a CSI report configured by omitting a specific group according to priorities of the plurality of groups.

2. The method of claim 1, wherein
the predefined specific index is associated with an index of the frequency domain of a strongest coefficient among the coefficients.

3. The method of claim 2, wherein
the predefined specific index is 0.

4. The method of claim 1, wherein
the priority values are determined based on i) layer indices, ii) indices of a spatial domain associated with the respective elements, and iii) indices of the frequency domain associated with the respective elements.

5. The method of claim 4, wherein
the priority values increase in ascending order of the indices of the spatial domain.

6. The method of claim 4, wherein
a priority of the respective elements is higher as the priority values are smaller.

7. The method of claim 4, wherein
a priority of i) an index of the spatial domain of the strongest coefficient and ii) an index of the spatial domain corresponding to a beam having opposite polarization with respect to a beam corresponding to the strongest coefficient is highest.

8. The method of claim 1, wherein
the CSI report is transmitted via a physical uplink shared channel (PUSCH).

9. The method of claim 1, wherein
the CSI report includes a first part and a second part, and the specific group to be included in the second part is omitted.

10. The method of claim 1, wherein
the CSI report further includes information related to omission of the specific group.

11. The method of claim 10, wherein
the information related to the omission includes information on at least one of i) whether to omit, ii) an omission subject, or iii) an omission quantity.

12. The method of claim 1, wherein
the information related to the coefficients includes at least one of i) information on a amplitude coefficient, ii) information on a phase coefficient, or iii) bitmap information related to the amplitude coefficient and the phase coefficient.

13. The method of claim 1, further comprising:
receiving configuration information related to the CSI from the BS,
wherein a resource region for the CSI report is allocated based on the configuration information, and a payload size of the calculated CSI exceeds the resource region.

14. A user equipment (UE) transmitting and receiving data in a wireless communication system, the UE comprising:
at least one transceiver;
at least one processor; and
at least one memory configured to store instructions regarding operations executed by the at least one processor and connected to the at least one processor,
wherein the operations comprise:
receiving, from a base station (BS) through the at least one transceiver, a reference signal;
calculating channel state information (CSI) based on the reference signal, wherein the CSI includes information related to coefficients, elements of the information related to the coefficients are classified into a plurality of groups based on priority values, respectively, and the priority values increase in order in which a higher index and a lower index of indices of a frequency domain associated with the elements are sequentially alternated based on a predefined specific index; and
transmitting, to the BS through the at least one transceiver, a CSI report configured by omitting a specific group according to priorities of the plurality of groups.

15. The method of claim 14, wherein
the predefined specific index is associated with an index of the frequency domain of a strongest coefficient among the coefficients.

16. The method of claim 14, wherein
the priority values are determined based on i) layer indices, ii) indices of a spatial domain associated with the respective elements, and iii) indices of the frequency domain associated with the respective elements.

17. The method of claim 16, wherein
the priority values increase in ascending order of the indices of the spatial domain.

18. A method of receiving channel state information (CSI) by a base station (BS) in a wireless communication system, the method comprising:
transmitting CSI-related configuration information to a user equipment (UE);
transmitting a reference signal to the UE; and
receiving CSI measured based on the reference signal from the UE,
wherein
the CSI includes information related to coefficients,
elements of the information related to the coefficients are classified into a plurality of groups based on priority values, respectively,
the priority values increase in order in which a higher index and a lower index of indices of a frequency domain associated with the elements are sequentially alternated based on a predefined specific index, and
a specific group is omitted according to priorities of the plurality of groups.

19. A base station (BS) for transmitting and receiving data in a wireless communication system, the BS comprising:
at least one transceiver;
at least one processor; and
at least one memory configured to store instructions regarding operations executed by the at least one processor and connected to the at least one processor,
wherein the operations comprise:
transmitting channel state information (CSI)-related configuration information to a user equipment (UE);
transmitting a reference signal to the UE; and
receiving CSI measured based on the reference signal from the UE,
wherein
the CSI includes information related to coefficients,
elements of the information related to the coefficients are classified into a plurality of groups based on priority values, respectively,
the priority values increase in order in which a higher index and a lower index of indices of a frequency domain associated with the elements are sequentially alternated based on a predefined specific index, and
a specific group is omitted according to priorities of the plurality of groups.
